(19) United States
(12) Patent Application Publication
(10) Pub. No.: US 2008/0118681 A1
(43) Pub. Date: May 22, 2008

(54) PRINTED WIRING BOARD MANUFACTURING APPARATUS, PRINTED WIRING BOARD, METHOD FOR MANUFACTURING PRINTED WIRING BOARD, AND ELECTRONIC DEVICE

(76) Inventor: Yukihiro UENO, Hiroshima (JP)

Correspondence Address: BIRCH STEWART KOLASCH & BIRCH, PO BOX 747, FALLS CHURCH, VA, 22040-0747, US

(21) Appl. No.: 11/865,613

(22) Filed: Oct. 1, 2007

(30) Foreign Application Priority Data
Nov. 20, 2006 (JP) 2006-313331

(51) Int. Cl. B32B 3/02; B32B 37/02

(52) U.S. Cl. 428/34.1; 118/73; 156/243; 156/345.12; 156/367; 156/379.6; 156/580; 156/580.2

(57) ABSTRACT

According to an embodiment of the present invention, a printed wiring board manufacturing apparatus being provided with a drum unit having a processing cylinder that holds the printed wiring board material and comprises a cylinder outer circumference and a processing unit that performs processing on the printed wiring board material held by the processing cylinder.

### BACKGROUND OF THE INVENTION

This application claims priority under 35 U.S.C. § 119(a) on Japanese Patent Application No. 2006-313331 filed in Japan on Nov. 20, 2006, the entire contents of which are hereby incorporated by reference.

The present invention relates to a printed wiring board manufacturing apparatus that manufactures a printed wiring board having a curved insulating substrate using a cylindrical body for processing having a cylindrical outer circumference, a printed wiring board having a curved insulating substrate, a method for manufacturing a printed wiring board having a curved insulating substrate, and an electronic device in which a printed wiring board having a curved insulating substrate is mounted.

A printed wiring board used in an electronic device is ordinarily flat. This is because most electronic devices are box-shaped, and so it is advantageous in terms of space that the shape of a printed wiring board mounted inside an electronic device is flat, or alternatively, a flat shape is advantageous when manufacturing the printed wiring board or when mounting a component.

On the other hand, reduced size of electronic devices is accompanied by reduced internal space in a case that houses an electronic circuit (a printed wiring board), and more complicated shapes. That is, with a conventional printed wiring board having a simple, flat shape, housing and interconnection of necessary electronic circuits may be difficult.

In order to address these problems, flexible film-like printed wiring boards (so-called flexible printed wiring boards), and rigid-flex printed wiring boards in which a portion of the printed wiring board is flexible, have been proposed, and manufactured.

Also, when there is a limit to the height of a mounted component, or when a special shape is required due to the space in which the printed wiring board is housed, printed wiring boards have been manufactured in which a conductive circuit is provided in an injection-molded resin material.

In an ordinary electronic device, when a conventional flexible printed wiring board or rigid-flex printed wiring board is used, it is possible for the flexible printed wiring board to be suitably compatible in such a case, but in the context of recent reductions in the size of electronic components, or requirements of design or the like, there are circumstances in which conventional compatibility cannot adequately satisfy the needs of an electronic device. As such an example, there are cases in which a printed wiring board is mounted in a cylindrical case.

FIG. 30 is a transparent side view that shows a state in which a printed wiring board serving as a conventional example has been mounted in an electronic device having a cylindrical case.

A conventional electronic device 500 is provided with a cylindrical case 501. Components 511 are mounted to a conventional printed wiring board 510 with a flat shape. The printed wiring board 510 cannot be bent, and therefore cannot have a shape with a width equal to or greater than the diameter of the cylinder.

Accordingly, there is the problem that it is difficult to increase the mounting density of components because the maximum size of the printed wiring board 510 is limited by the diameter, and so the surface area of the printed wiring board 510 itself is also small. Also, there is the problem that because the position where the printed wiring board 510 is disposed is limited, space efficiency is very poor, so it is difficult to reduce the size of the electronic device 500.

It is conceivable that using the printed wiring board in a state bent along the inner wall face of the case 501 by adopting a flexible printed wiring board as the printed wiring board 510 is desirable, but in actuality, the flexible printed wiring board itself is manufactured with a flat shape, and so there are risks that a break will occur and that layers will peel away from each other, if the printed wiring board bends in the area of a through-hole, a land portion for mounting a component, or the like. As a result, there is the problem that curving of the printed wiring board in a shape that follows the case 501 has not been realized.

Although technology for bending a flexible printed wiring board has been proposed, but the portion that is bent is limited to simply a portion where a lead wire has been formed, and in reality the bend in the area of a through-hole, a land portion for mounting a component, or the like is not intended (for example, see JP 2000-40865A).

FIG. 31 is a transparent side view that shows a state in which a rigid-flex printed wiring board serving as a conventional example has been mounted in an electronic device having a cylindrical case.

The conventional electronic device 500 is provided with the case 501. Components 521 are mounted to the conventional printed wiring board 520. Because a rigid-flex printed wiring board is used for the printed wiring board 520, the printed wiring board 520 has hard portions 520a and flexible portions 520b that can be bent. Accordingly, the hard portions 520a and the flexible portions 520b are alternately disposed, and the printed wiring board 520 is bent at the flexible portions 520b, so the printed wiring board 520 can be disposed along the inner wall face of the case 501.

However, because it is necessary to form the hard portions 520a and the flexible portions 520b in the rigid-flex printed wiring board, there is the problem that the structure of the printed wiring board is complicated and so manufacturing cost increases. There are also other problems, such as that components can only be mounted to the hard portions 520a, and so in actuality it is difficult to increase the surface area that can be used for mounting components.

Against the conventional examples shown in FIGS. 30 and 31, technology for forming a three-dimensional circuit without applying a printed wiring board has been proposed (for example, see JP 2001-196705A and JP 2001-230524A). Specifically, with this technology, plastic molding is used to form a solid molded substrate with a shape that follows the inner face of the case, and components are mounted to the molded substrate.

Although technology applying a three-dimensional molded substrate appears to be ideal, many problems occur. For example, injection molding dies are expensive, and formation of a solid molding substrate and formation of a wiring pattern are labor-intensive. At the same time, there are many limitations arising from the applied materials and the manufacturing method, so there is the problem that it is difficult to realize high density, high precision, and high reliability in the manner of an ordinary printed wiring board.

Also, ordinarily, in the manufacturing facilities of printed wiring boards, there are many manufacturing apparatuses such as etching apparatuses and plating apparatuses, and in particular, there is the problem that these manufacturing apparatuses are long, with a length spanning tens of meters, and so factory floor area is large.

### SUMMARY OF THE INVENTION

The present invention was made in view of such circumstances, and it is an object thereof to provide a printed wiring board manufacturing apparatus that easily manufactures a printed wiring board apparatus having a curved shape by applying a processing cylinder that holds a printed wiring board material in a printed wiring board manufacturing apparatus that manufactures a printed wiring board by performing processing on a printed wiring board material subjected to processing.

It is another object of the present invention to provide, by curving an insulating substrate of a printed wiring board, in which a wiring pattern including a component mounting land portion has been formed, in an area where the component mounting land portion has been curved, a printed wiring board in which the component mounting area is curved, and can thus be mounted and disposed in a small space, so that the printed wiring board is highly adaptable to an electronic device.

It is another object of the invention to provide, by performing processing on a printed wiring board using a processing cylinder in a printed wiring board manufacturing method in which printed wiring board material with which a printed wiring board is formed is layered, and processing is performed on the printed wiring board material to form a printed wiring board, a printed wiring board manufacturing method with which it is possible to easily manufacture a printed wiring board in which the component mounting area is curved, so the printed wiring board can be mounted and disposed in a small space, and thus the printed wiring board is highly adaptable to an electronic device.

It is another object to provide an electronic device in which a printed wiring board is mounted, a component being mounted on the printed wiring board, wherein due to the printed wiring board being a printed wiring board according to the present invention, mounting density is high, and a reduction in size is possible in a shape consistent with the intended use of the electronic device.

A printed wiring board manufacturing apparatus according to the present invention is a printed wiring board manufacturing apparatus that manufactures a printed wiring board by performing processing on a printed wiring board material serving as a processing subject, the printed wiring board manufacturing apparatus being provided with a drum unit having a processing cylinder that holds the printed wiring board material and comprises a cylinder outer circumference; and a processing unit that performs processing on the printed wiring board material held by the processing cylinder.

With this configuration, film-like printed wiring board material is layered (affixed) on the surface of the cylindrical outer circumference of the processing cylinder, and fluid-like printed wiring board material is applied, or these steps are repeated, so that it is possible to perform processing of printed wiring board material (mechanical processing such as hole processing, plating treatment such as panel plating, or other processing necessary for manufacturing a printed wiring board), and thus it is possible to very easily and smoothly manufacture a printed wiring board having a curved shape that corresponds to the surface shape of the processing cylinder.

Also, with the printed wiring board manufacturing apparatus according to the present invention, the drum unit is provided with a temperature adjustment mechanism.

With this configuration, the printed wiring board material can be placed in an appropriate temperature state, and in a state suitable for processing, high precision and efficient processing is possible.

Also, with the printed wiring board manufacturing apparatus according to the present invention, the temperature adjustment mechanism is configured to perform temperature adjustment with a supply of electric current.

With this configuration, temperature can be adjusted by controlling electric current, so simple and precise temperature control is possible.

Also, with the printed wiring board manufacturing apparatus according to the present invention, the temperature adjustment mechanism is configured to perform temperature adjustment with a supply of fluid.

With this configuration, it is possible to comparatively easily supply a heating medium/refrigerant, and thus to efficiently perform heating/cooling.

Also, with the printed wiring board manufacturing apparatus according to the present invention, the drum unit is provided with an ultrasonic vibrator.

With this configuration, it is possible to precisely perform processing by increasing the processing efficiency, by vibrating the surface of the processing cylinder.

Also, with the printed wiring board manufacturing apparatus according to the present invention, the processing cylinder has a processing jig plate divided in the outer circumferential direction, and is configured to change the radius of the cylinder outer circumference, which is configured by the processing jig plate, in a range from tens of μm to tens of mm.

With this configuration, it is possible to easily remove a printed wiring board whose processing has ended from the drum unit, without making the range of movement of the processing cylinder larger than necessary.

Also, with the printed wiring board manufacturing apparatus according to the present invention, the processing cylinder has the shape of a cylinder or a polygonal pillar.

With this configuration, it is possible for the processing cylinder to be suitable for a printed wiring board serving as a processing subject, and so processing can be performed precisely and efficiently.

Also, with the printed wiring board manufacturing apparatus according to the present invention, a rotational drive unit that rotationally drives the drum unit is provided.

With this configuration, it is possible to process the printed wiring board material by controlling rotation of the drum unit, and thus it is possible to perform processing in which the outer circumference of the cylinder of the processing cylinder is effectively utilized.

Also, with the printed wiring board manufacturing apparatus according to the present invention, the rotational drive unit is provided with a drive control portion that controls rotation of the drum unit, and an interface portion that links to the processing unit.

With this configuration, it is possible to efficiently and precisely perform processing in association with the processing unit by controlling rotation of the processing cylinder.

Also, with the printed wiring board manufacturing apparatus according to the present invention, the processing unit is a film layering unit that layers printed wiring board material on the processing cylinder, the film layering unit being provided with a roll material supply mechanism that supplies to the processing cylinder, in a state maintaining tensile force, printed wiring board material rolled up in a roll, and a pressing mechanism that applies pressure to printed wiring board material supplied to the processing cylinder.

With this configuration, it is possible to layer (affix) printed wiring board material rolled up in a roll by continuously supplying that material and affixing the supplied material to the processing cylinder with pressure.

Also, with the printed wiring board manufacturing apparatus according to the present invention, the processing unit is a film layering unit that layers printed wiring board material on the processing cylinder, the film layering unit being provided with a sheet material supply mechanism that supplies to the processing cylinder, in a state maintaining tensile force, sheet-like printed wiring board material, and a pressing mechanism that applies pressure to printed wiring board material supplied to the processing cylinder.

With this configuration, it is possible to layer (affix) sheet-like printed wiring board material supplying that material and affixing the supplied material to the processing cylinder with pressure.

Also, with the printed wiring board manufacturing apparatus according to the present invention, the printed wiring board manufacturing apparatus is provided with a light-blocking mechanism that blocks light from printed wiring board material that is photosensitive.

With this configuration, it is possible to very easily supply and layer photosensitive printed wiring board material to a processing cylinder, and easily and accurately perform necessary exposure treatment.

Also, with the printed wiring board manufacturing apparatus according to the present invention, the processing unit is a laser exposure unit, the laser exposure unit being provided with a laser exposure head that, in a state in which the drum unit has been installed in the rotational drive unit, irradiates a laser beam synchronized with rotation of the processing cylinder onto printed wiring board material that has been layered on the surface of the processing cylinder, and a head movement portion that moves the laser exposure head parallel to the rotational shaft.

With this configuration, it is possible to perform exposure by applying a laser beam, so laser exposure can be performed effectively and precisely.

Also, with the printed wiring board manufacturing apparatus according to the present invention, the processing unit is a development unit provided with a rotational drive portion that rotationally drives the drum unit, and a development treatment fluid supply portion that supplies a treatment fluid for development to the processing cylinder.

With this configuration, it is possible to perform development and washing easily and precisely for photosensitive resin that has been exposed in a state layered on a processing cylinder.

Also, with the printed wiring board manufacturing apparatus according to the present invention, the processing unit is a simplified development unit provided with a development treatment fluid supply portion that supplies a treatment fluid for development to the processing cylinder in a state in which the drum unit has been installed in the rotational drive unit.

With this configuration, it is possible to adopt a simplified processing unit in which rotational drive portion of the development unit has been omitted, and so it is possible to perform development and washing easily and precisely for photosensitive resin that has been exposed in a state layered on a processing cylinder.

Also, with the printed wiring board manufacturing apparatus according to the present invention, the processing unit is a plating pretreatment unit provided with a treatment tank that houses the drum unit, and a treatment fluid circulation apparatus that circulates treatment fluid injected into the treatment tank around the circumference of the drum unit.

With this configuration, it is possible to efficiently and precisely perform plating pretreatment. Also, it is possible to configure an electroless plating unit by switching treatment fluid to electroless plating fluid.

Also, with the printed wiring board manufacturing apparatus according to the present invention, the plating pretreatment unit is provided with a plurality of treatment fluid tanks in which different treatment fluids are respectively stored, a discharge fluid pipe that discharges treatment fluid injected into the treatment tank, and a treatment fluid switching mechanism that injects a different treatment fluid than the discharged treatment fluid.

With this configuration, it is possible to perform different processing consecutively by switching treatment fluids, so efficient plating pretreatment can be performed. Also, it is possible to configure an electroless plating unit by changing the treatment fluid to electroless plating fluid.

Also, with the printed wiring board manufacturing apparatus according to the present invention, the processing unit is an electroless plating unit provided with a treatment tank that houses the drum unit, and a treatment fluid circulation apparatus that circulates electroless plating fluid injected into the treatment tank around the circumference of the drum unit.

With this configuration, it is possible to efficiently and precisely perform electroless plating.

Also, with the printed wiring board manufacturing apparatus according to the present invention, the processing unit is an electrolytic plating unit provided with a plating tank that houses the drum unit, a plating fluid circulation apparatus that circulates electrolytic plating fluid injected into the plating tank around the circumference of the drum unit, and a plating electric current supply portion that supplies a plating electric current necessary for electrolytic plating treatment.

With this configuration, it is possible to efficiently and precisely perform electrolytic plating treatment.

Also, with the printed wiring board manufacturing apparatus according to the present invention, the electrolytic plating unit is provided with a plating precision adjustment mechanism that adjusts a state of circulation of electrolytic plating fluid, or a state of the surface of printed wiring board material.

With this configuration, it is possible to adjust the circulation state of electrolytic plating fluid or the surface state of printed wiring board material, thus improving plating precision.

Also, with the printed wiring board manufacturing apparatus according to the present invention, the electrolytic plating unit is provided with an anode mud treatment portion that treats anode mud.

With this configuration, it is possible to efficiently treat anode mud to increase electrolytic plating efficiency, and improve the usage efficiency of a plating tank.

Also, with the printed wiring board manufacturing apparatus according to the present invention, the plating tank is provided with an exhaust treatment portion that recovers and treats exhaust generated from the plating tank during electrolytic plating treatment.

With this configuration, it is possible to adopt an electrolytic plating unit that safely performs electrolytic plating treatment.

Also, with the printed wiring board manufacturing apparatus according to the present invention, the plating tank is a cylindrical vertical-type plating tank in which the drum unit is disposed in the vertical direction.

With this configuration, it is possible to store the drum unit with good storability and symmetry, and thus perform plating treatment with a small amount of electrolytic plating fluid.

Also, with the printed wiring board manufacturing apparatus according to the present invention, an anode electrode serving as the plating electric current supply portion is disposed along an inner wall of the plating tank.

With this configuration, it is possible to apply a highly uniform electric field to the drum unit, and so it is possible to perform electrolytic plating with high precision.

Also, with the printed wiring board manufacturing apparatus according to the present invention, a gap between the anode electrode and the processing cylinder is uniform.

With this configuration, it is possible to make uniform the electric field applied to printed wiring board material serving as a subject of electrolytic plating treatment, and thus it is possible to perform uniform electrolytic plating.

Also, with the printed wiring board manufacturing apparatus according to the present invention, the gap between the anode electrode and the processing cylinder is in a range from 5 mm to 30 cm.

With this configuration, it is possible to precisely and efficiently perform electrolytic plating.

Also, with the printed wiring board manufacturing apparatus according to the present invention, the anode electrode is disposed at a position facing the processing cylinder, and the length of the anode electrode in the vertical direction is not less than the length of the processing cylinder.

With this configuration, it is possible to make the electric field applied to the processing cylinder uniform, and so it is possible to precisely and efficiently perform electrolytic plating treatment.

Also, with the printed wiring board manufacturing apparatus according to the present invention, the plating tank is a vertical rectangular body in which the drum unit is disposed in the vertical direction.

With this configuration, it is possible to make the shape of a side wall of the plating tank flat, so it is possible to simplify the structure of an anode electrode shape, a pipe shape, or the like.

Also, with the printed wiring board manufacturing apparatus according to the present invention, the anode electrode serving as the plating electric current supply portion is bar-shaped, and is disposed at a corner in at least one location in the plating tank.

With this configuration, it is possible to simplify the configuration of the anode electrode, so it is possible to easily perform an anode electrode measure.

Also, with the printed wiring board manufacturing apparatus according to the present invention, the anode electrode serving as the plating electric current supply portion is plate-shaped, and is disposed along at least one face of the plating tank.

With this configuration, it is possible to simplify the configuration of the anode electrode, so it is possible to easily perform an anode electrode measure.

Also, with the printed wiring board manufacturing apparatus according to the present invention, the plating tank is a horizontal articulating-type plating tank in which a plurality of the drum units disposed in the vertical direction are arranged in a horizontal line.

With this configuration, it is possible to arrange a plurality of drum units in a line and simultaneously perform electrolytic plating treatment, so electrolytic plating treatment can be performed with good productivity.

Also, with the printed wiring board manufacturing apparatus according to the present invention, the processing unit is a laser processing unit, the laser processing unit being provided with a laser processing head that, in a state in which the drum unit has been installed in the rotational drive unit, irradiates a laser beam synchronized with rotation of the processing cylinder onto printed wiring board material that has been layered on the surface of the processing cylinder, and a head movement portion that moves the laser processing head parallel to the rotational shaft.

With this configuration, it is possible to perform processing by applying a laser beam, so laser processing can be performed effectively and precisely.

Also, with the printed wiring board manufacturing apparatus according to the present invention, the light source of the laser beam is a carbon dioxide gas laser or a YAG laser.

With this configuration, output can be increased, so laser processing can be performed with good processability.

Also, with the printed wiring board manufacturing apparatus according to the present invention, the processing unit is an application unit comprising an application fluid supply portion that supplies application fluid, and an application portion that applies application fluid supplied from the application fluid supply portion onto printed wiring board material that has been layered on the surface of the processing cylinder.

With this configuration, it is possible to easily and precisely form a resin film by supplying and applying application fluid to the processing cylinder.

Also, with the printed wiring board manufacturing apparatus according to the present invention, the application unit is provided with a film quality change portion that changes the application fluid that has been applied to the printed wiring board material to a resin film having a predetermined film quality.

With this configuration, it is possible to easily and precisely change application fluid to a resin film of a predetermined quality.

Also, with the printed wiring board manufacturing apparatus according to the present invention, the processing unit is a vacuum press unit provided with a vacuum bag that houses the drum unit, a depressurizing apparatus that depressurizes the vacuum bag housing the drum unit, and a heating apparatus that heats the depressurized vacuum bag.

With this configuration, it is possible to easily apply heat and pressure to the printed wiring board material formed by layering on the surface of the processing cylinder, and so layered printed wiring board materials can be easily affixed to each other.

Also, with the printed wiring board manufacturing apparatus according to the present invention, the processing unit is a mold pressing unit provided with a plurality of pressing molds that apply pressure and heat from the circumference of the processing cylinder, and a pressing mold drive portion that controls driving of the pressing molds.

With this configuration, without using a vacuum apparatus, it is possible to, easily and with a simple structure, affix the printed wiring board material layered and formed on the surface of the processing cylinder by pressing.

Also, with the printed wiring board manufacturing apparatus according to the present invention, the temperature adjustment mechanism is configured to operate in synchronization with the processing unit.

With this configuration, it is possible to perform temperature adjustment of printed wiring board material in coordination with a vacuum pressing unit or a mold pressing unit, so it is possible to swiftly and effectively affix the printed wiring board material by pressing.

Also, with the printed wiring board manufacturing apparatus according to the present invention, the processing unit is a print unit provided with an ink ejection head that, in a state in which the drum unit has been installed in the rotational drive unit, in synchronization with rotation of the processing cylinder, ejects printing ink to printed wiring board material that has been layered on the surface of the processing cylinder, and a head movement portion that moves the ink ejection head parallel to the rotational shaft.

With this configuration, it is possible to perform printing by applying printing ink, and thus printing can be performed effectively and precisely.

Also, with the printed wiring board manufacturing apparatus according to the present invention, the print unit is provided with an ink drying apparatus that dries printing ink that has been ejected to printed wiring board material.

With this configuration, it is possible to effectively dry printing ink in a clean state.

Also, with the printed wiring board manufacturing apparatus according to the present invention, the temperature adjustment apparatus is configured to operate in synchronization with the ink drying apparatus.

With this configuration, it is possible to more effectively and swiftly dry printing ink.

Also, with the printed wiring board manufacturing apparatus according to the present invention, the processing unit is a post-curing unit provided with an electromagnetic wave irradiation portion that, in a state in which the drum unit has been installed in the rotational drive unit, irradiates electromagnetic waves for post-curing to the processing cylinder.

With this configuration, it is possible to irradiate ultraviolet rays/X-rays as post-curing electromagnetic waves, and so it is possible to easily and precisely perform post-curing of printed wiring board material layered on a processing cylinder.

Also, with the printed wiring board manufacturing apparatus according to the present invention, the processing unit is a polishing unit provided with a rotational drive portion that rotationally drives the drum unit, a polishing portion that polishes printed wiring board material that has been layered on the surface of the processing cylinder, and a polishing moving portion that moves the polishing portion parallel to the rotational shaft.

With this configuration, it is possible to suppress deformation of printed wiring board material due to polishing, and so it is possible to maintain and improve dimensional accuracy of the printed wiring board.

Also, with the printed wiring board manufacturing apparatus according to the present invention, the processing unit is an etching unit provided with a rotational drive portion that rotationally drives the drum unit, and an etching fluid supply portion that supplies etching fluid to the processing cylinder.

With this configuration, etching can be performed easily and precisely on an etching subject in which a resist pattern has been formed in a state applied to a processing cylinder, so it is possible to maintain and improve dimensional accuracy of the printed wiring board.

Also, the printed wiring board according to the present invention is a printed wiring board in which a wiring pattern having a component mounting land portion has been formed on an insulating substrate, in which the insulating substrate is curved in an area where the component mounting land portion has been formed.

With this configuration, the component mounting area can be curved, so mounting and disposal in a small space is possible, and thus the printed wiring board is highly adaptable to the case of an electronic device.

Also, with the printed wiring board according to the present invention, the insulating substrate has the shape of a cylinder.

With this configuration, it is possible to mount components in a cylindrical manner, and so the printed wiring board is highly adaptable to an electronic device having a cylindrical case.

Also, with the printed wiring board according to the present invention, a conductor layer different from a conductor layer comprising the component mounting land portion is formed.

With this configuration, the printed wiring board becomes a multiplayer printed wiring board with high wiring density.

Also, the method for manufacturing a printed wiring board according to the present invention is a method for manufacturing a printed wiring board by layering a printed wiring board material with which a printed wiring board is formed, and performing processing on the printed wiring board material, the method including a cylinder preparation step of preparing a processing cylinder on which printed wiring board material will be layered; a material layering step of layering printed wiring board material on the processing cylinder; a processing step of performing processing on the printed wiring board material that has been layered on the processing cylinder; and a removal step of removing a printed wiring board formed by repeating the material layering step and the processing step from the processing cylinder.

With this configuration, an effect is attained that it is possible to precisely, easily, and reliably manufacture a printed wiring board in which the component mounting area is curved, and can thus be mounted and disposed in a small space, so that the printed wiring board is highly adaptable to an electronic device.

Also, the electronic device according to the present invention is an electronic device in which a printed wiring board is mounted, a component being mounted on the printed wiring board, in which the printed wiring board is a printed wiring board according to the present invention.

With this configuration, a printed wiring board having high mounting density and a shape curved matching the case of the electronic device is provided, so the size of the electronic device can be reduced in a shape consistent with the intended use of the electronic device.

With the printed wiring board manufacturing apparatus according to the present invention, because a processing cylinder that holds printed wiring board material is applied in a printed wiring board manufacturing apparatus that manufactures a printed wiring board by performing processing on a printed wiring board material as a processing subject, an effect is attained that it is possible to easily manufacture a printed wiring board having a curved shape. Also, it is possible to suppress dimensional change during processing, so it is possible to manufacture a printed wiring board with high dimensional precision. Because processing is performed by applying a processing cylinder, an effect is attained that it is possible to greatly reduce the installation area in comparison to a conventional manufacturing apparatus.

With the printed wiring board according to the present invention, an insulating substrate of a printed wiring board, in which a wiring pattern including a component mounting land portion has been formed, is curved in an area where the component mounting land portion has been formed, so an effect is attained that it is possible to curve the component mounting area, and thus mount and dispose the printed wiring board in a small space, so that the adaptability of the printed wiring board to an electronic device can be improved. In particular an effect is attained that the printed wiring board can be adapted to an electronic device whose case is curved.

With the method for manufacturing a printed wiring board according to the present invention, in a method of manufacturing a printed wiring board that manufactures a printed wiring board by layering and processing printed wiring board material with which a printed wiring board is formed, processing is performed on the printed wiring board material using a processing cylinder, so an effect is attained that it is possible to easily manufacture a printed wiring board in which the component mounting area is curved, and can thus be mounted and disposed in a small space, so that the printed wiring board is highly adaptable to an electronic device. Also, because it is possible to apply conventional printed wiring board materials and processing, an effect is attained that it is possible to manufacture a highly reliable printed wiring board.

With the electronic device according to the present invention, because a printed wiring board according to the present invention is mounted, an effect is attained that it is possible for the electronic device to have high mounting density, and for the size of the electronic device to be reduced in a shape that is consistent with the intended use of the electronic device.

### BRIEF DESCRIPTION OF THE DRAWINGS

FIG. 1A is a perspective view that schematically shows a printed wiring board according to Embodiment 1 of the present invention, and shows a case of adopting a cylindrical insulating substrate (printed wiring board).

FIG. 1B is a perspective view that schematically shows a printed wiring board according to Embodiment 1 of the present invention, and shows a case of adopting a curved arc-like insulating substrate (printed wiring board).

FIG. 2 is a perspective view that shows the general configuration of a drum unit serving as a constituent element of a printed wiring board manufacturing apparatus according to Embodiment 2 of the present invention.

FIG. 3 is a perspective view that shows the general configuration of a rotational drive unit serving as a constituent element of the printed wiring board manufacturing apparatus according to Embodiment 2 of the present invention.

FIG. 4A is a side view that conceptually shows the general configuration of a film layering unit that is one example of a processing unit serving as a constituent element of the printed wiring board manufacturing apparatus according to Embodiment 2 of the present invention, in which a roll-like printed wiring board material is applied.

FIG. 4B is a side view that conceptually shows the general configuration of a film layering unit that is one example of a processing unit serving as a constituent element of the printed wiring board manufacturing apparatus according to Embodiment 2 of the present invention, in which a sheet-like printed wiring board material is applied.

FIG. 5 is a cross-sectional view that shows the cross-sectional state of an example printed wiring board obtained by layering printed wiring board material on processing cylinder using the film layering unit shown in FIG. 4.

FIG. 6 is a transparent perspective view that conceptually shows the transparently viewed general configuration of a vacuum press unit that is one example of a processing unit serving as a constituent element of the printed wiring board manufacturing apparatus according to Embodiment 2 of the present invention.

FIG. 7A is a cross-sectional view that shows the cross-sectional state of the printed wiring board shown in FIG. 5, in a state with an etching resist film formed as a printed wiring board material in a first conductor layer.

FIG. 7B is a perspective view that conceptually shows the general configuration of a laser exposure unit that is one example of a processing unit serving as a constituent element of the printed wiring board manufacturing apparatus according to Embodiment 2 of the present invention.

FIG. 7C is a block diagram that shows the block configuration of the laser exposure unit shown in FIG. 7B.

FIG. 8 is a perspective view that conceptually shows the general configuration of a development unit that is one example of a processing unit serving as a constituent element of the printed wiring board manufacturing apparatus according to Embodiment 2 of the present invention.

FIG. 9A is an explanatory diagram that illustrates a state in which a wiring pattern (a first conductor layer pattern) is formed by etching the printed wiring board material (a first conductor layer) shown in FIG. 5, and is a cross-sectional diagram that shows the cross-sectional state of an example printed wiring board obtained by forming a wiring pattern (the first conductor layer pattern).

FIG. 9B is an explanatory diagram that illustrates a state in which a wiring pattern (a first conductor layer pattern) is formed by etching the printed wiring board material (a first conductor layer) shown in FIG. 5, and is a perspective view that conceptually shows the general configuration of an etching unit that is one example of a processing unit serving as a constituent element of the printed wiring board manufacturing apparatus according to Embodiment 2 of the present invention.

FIG. 10 is a cross-sectional diagram that shows the cross-sectional state of an example printed wiring board obtained by layering printed wiring board material (an interlayer insulating resin layer and a second conductor layer) on the first conductor layer pattern shown in FIG. 9A.

FIG. 11 is a cross-sectional diagram that shows the cross-sectional state of an example printed wiring board in which a via hole is formed in the interlayer insulating resin layer and the second conductor layer shown in FIG. 10.

FIG. 12 is a cross-sectional diagram that shows the cross-sectional state of an example printed wiring board in which a panel plating layer is formed in the via hole shown in FIG. 11.

FIG. 13A is a transparent side view that conceptually shows, in a transparent state, the general configuration of a plating pretreatment/electroless plating unit that is one example of a processing unit serving as a constituent element of the printed wiring board manufacturing apparatus according to Embodiment 2 of the present invention.

FIG. 13B is a perspective view that conceptually shows another example of an agitating swinging mechanism applied in the plating pretreatment/electroless plating unit shown in FIG. 13A.

FIG. 14A is a transparent side view that conceptually shows, in a transparent state, the general configuration of an electrolytic plating unit that is one example of a processing unit serving as a constituent element of the printed wiring board manufacturing apparatus according to Embodiment 2 of the present invention.

FIG. 14B is a transparent side view that conceptually shows, in a transparent state, an example of an anode mud recovery treatment mechanism and an aeration mechanism that are applied in the electrolytic plating unit shown in FIG. 14A.

FIG. 15A is a perspective view that conceptually shows the general configuration of a polishing unit that is one example of a processing unit serving as a constituent element of the printed wiring board manufacturing apparatus according to Embodiment 2 of the present invention.

FIG. 15B is a cross-sectional diagram that shows the cross-sectional state of a printed wiring board in which a second conductor layer pattern is formed by patterning the panel plating layer shown in FIG. 12 and a second conductor layer.

FIG. 15C is a cross-sectional view that shows the cross-sectional state of a printed wiring board in which a solder resist is formed on the second conductor layer pattern formed in FIG. 15B.

FIG. 16A is a perspective view that conceptually shows the general configuration of one example of a processing unit serving as a constituent element of the printed wiring board manufacturing apparatus according to Embodiment 2 of the present invention.

FIG. 16B is a block diagram that shows the block configuration of a printing unit shown in FIG. 16A.

FIG. 17A is a side view that conceptually shows a state immediately after a printed wiring board manufactured by the printed wiring board manufacturing apparatus according to Embodiment 2 of the present invention has been formed in a processing cylinder.

FIG. 17B is a perspective view that schematically shows a state in which the printed wiring board shown in FIG. 17A is cut by a laser.

FIG. 17C is a side view that conceptually shows a state in which the printed wiring board shown in FIG. 17A has been separated from the processing cylinder.

FIG. 17D is a perspective view that conceptually shows a state in which the printed wiring board shown in FIG. 17C has been removed from the processing cylinder and thus completed.

FIG. 18 is a cross-sectional view that shows the cross-sectional state of a printed wiring board formed by a printed wiring board manufacturing apparatus (printed wiring board manufacturing method) according to Embodiment 3 of the present invention.

FIG. 19A is a cross-sectional view that shows the cross-sectional state of a printed wiring board formed by a printed wiring board manufacturing apparatus (printed wiring board manufacturing method) according to Embodiment 3 of the present invention.

FIG. 19B is a cross-sectional view that shows the cross-sectional state of a printed wiring board formed by a printed wiring board manufacturing apparatus (printed wiring board manufacturing method) according to Embodiment 3 of the present invention.

FIG. 20 is a cross-sectional view that shows the cross-sectional state of a printed wiring board formed by a printed wiring board manufacturing apparatus (printed wiring board manufacturing method) according to Embodiment 4 of the present invention.

FIG. 21A is a cross-sectional view that shows the cross-sectional state of a printed wiring board formed by a printed wiring board manufacturing apparatus (printed wiring board manufacturing method) according to Embodiment 5 of the present invention.

FIG. 21B is a cross-sectional view that shows the cross-sectional state of a printed wiring board formed by a printed wiring board manufacturing apparatus (printed wiring board manufacturing method) according to Embodiment 5 of the present invention.

FIG. 22 is a side view that conceptually shows the general configuration of an application unit that is one example of a processing unit serving as a constituent element of the printed wiring board manufacturing apparatus (printed wiring board manufacturing method) according to Embodiment 7 of the present invention.

FIG. 23 is a side view that conceptually shows the general configuration of a modified example of an application unit that is one example of a processing unit serving as a constituent element of the printed wiring board manufacturing apparatus (printed wiring board manufacturing method) according to Embodiment 7 of the present invention.

FIG. 24 is a perspective view that conceptually shows the general configuration of a modified example of an electrolytic plating unit that is one example of a processing unit that serves as a constituent element of the printed wiring board manufacturing apparatus (printed wiring board manufacturing method) according to Embodiment 8 of the present invention.

FIG. 25 is a perspective view that conceptually shows the general configuration of a modified example of an electrolytic plating unit that is one example of a processing unit that serves as a constituent element of the printed wiring board manufacturing apparatus (printed wiring board manufacturing method) according to Embodiment 8 of the present invention.

FIG. 26 is a perspective view that conceptually shows the general configuration of a modified example of an electrolytic plating unit that is one example of a processing unit that serves as a constituent element of the printed wiring board manufacturing apparatus (printed wiring board manufacturing method) according to Embodiment 8 of the present invention.

FIG. 27 is a perspective view that conceptually shows the general configuration of a shaping press unit that is one example of a processing unit that serves as a constituent element of the printed wiring board manufacturing apparatus (printed wiring board manufacturing method) according to Embodiment 9 of the present invention.

FIG. 28 is a perspective view that conceptually shows the general configuration of a drum unit that is one example of a processing unit that serves as a constituent element of the printed wiring board manufacturing apparatus (printed wiring board manufacturing method) according to Embodiment 12 of the present invention.

FIG. 29 is a transparent side view that illustrates a mounting state of a printed wiring board according to the present invention in an electronic device according to Embodiment 13 of the present invention.

FIG. 30 is a transparent side view that shows a state in which a printed wiring board serving as a conventional example has been mounted in an electronic device having a cylindrical case.

FIG. 31 is a transparent side view that shows a state in which a rigid-flex printed wiring board serving as a conventional example has been mounted in an electronic device having a cylindrical case.

### DESCRIPTION OF THE PREFERRED EMBODIMENTS

Hereinafter, embodiments of the present invention will be described in detail with reference to the accompanying drawings.

### Embodiment 1

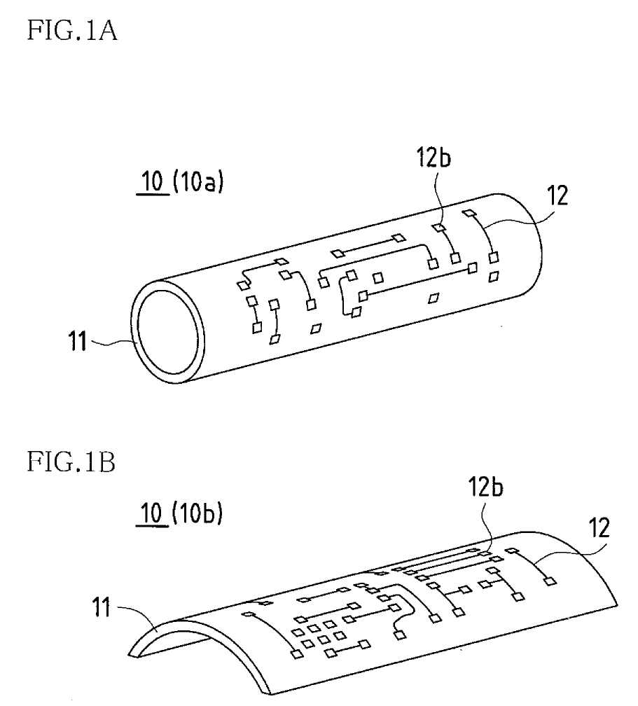

FIGS. 1A and 1B are perspective views that schematically show a printed wiring board according to Embodiment 1 of the present invention. FIG. 1A shows a case in which that printed wiring board is a cylindrical insulating substrate (printed wiring board), and FIG. 1B shows a case in which that printed wiring board is a curved arc-like insulating substrate (printed wiring board).

A printed wiring board 10 according to Embodiment 1 is provided with a curved insulting substrate 11 serving as a wiring substrate, and a wiring pattern 12 provided by a conductor layer formed on the insulating substrate 11. The wiring pattern 12 has a component mounting land portion 12b in a curved area of the insulating substrate 11.

More specifically, the printed wiring board 10 according to Embodiment 1 is a printed wiring board with the wiring pattern 12 having the component mounting land portion 12b formed in the insulating substrate 11, and the insulating substrate 11 is curved in the area where the component mounting land portion 12b is formed. With this configuration, it is possible to manufacture the printed wiring board 10 such that a component mounting area defined by the component mounting land portion 12b is curved, and so the printed wiring board 10 can be mounted and arranged in a small space. Thus mountability of the printed wiring board 10 can be improved and the printed wiring board 10 has high reliability.

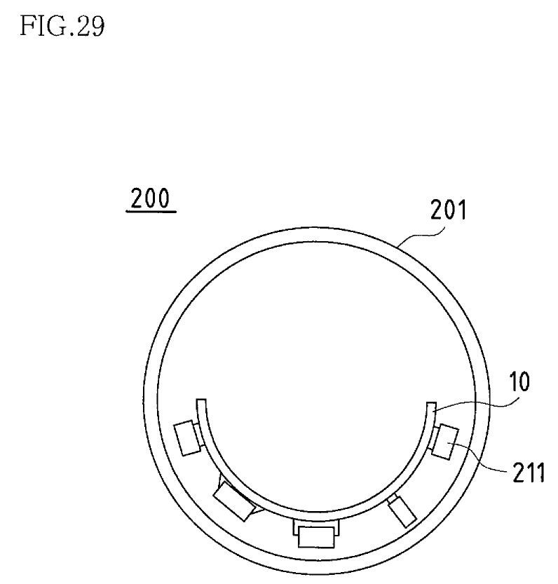

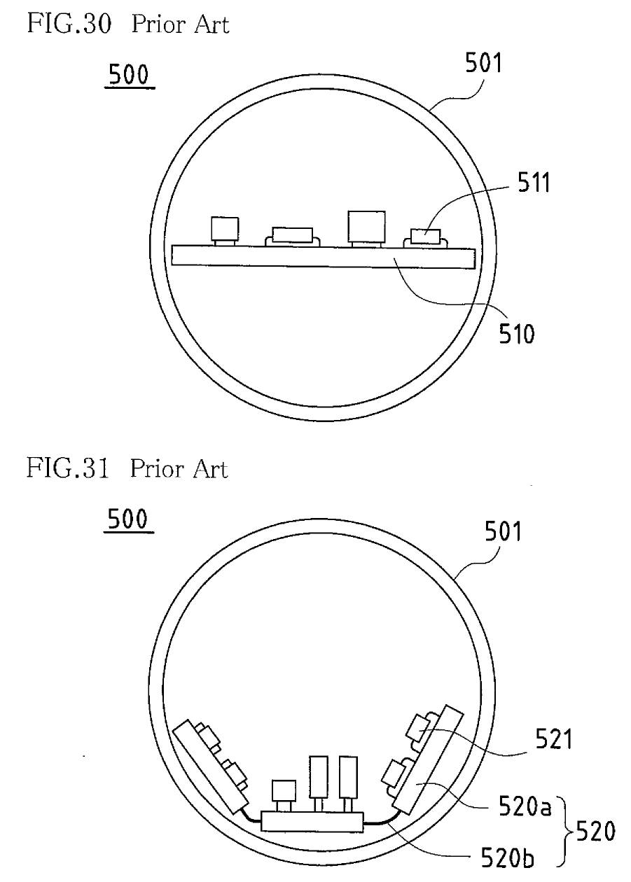

Also, because a cylindrical printed wiring board 10 (10a) can be configured by adopting a cylindrical shape for the insulating substrate 11 (FIG. 1A), components can be mounted in a cylindrical shape. Accordingly, it is possible to provide a printed wiring board 10 that is highly adaptable to an electronic device 200 that has a cylindrical case 201 (see FIG. 29).

Because the printed wiring board 10 has a shape that is curved in advance, the printing wiring board 10 can be disposed corresponding to the shape of the electronic device 200, and so the size of the electronic device 200 can be reduced. That is, the printed wiring board 10 according to Embodiment 1 attains an effect of being particularly suitable to an electronic device that is curved.

The manufacturing method and manufacturing apparatus of the printed wiring board 10 are described in Embodiment 2. However, note that after formation in the state shown in FIG. 1A, by dividing into a plurality of sections in the circumferential direction of the cylindrical shape, it is possible to configure (FIG. 1B) a curved arc-like printed wiring board 10 (10b) that constitutes a portion of the cylindrical shape. Below, when it is not particularly necessary to distinguish between the cylindrical printed wiring board 10a and the arc-like printed wiring board 10b, reference is made to simply the printed wiring board 10.

Also, because the wiring density and number of layers can be made the same as in a conventional, flat printed wiring board, it is possible for the printed wiring board 10 to have high wiring density and high mounting density even in a curved state.

### Embodiment 2

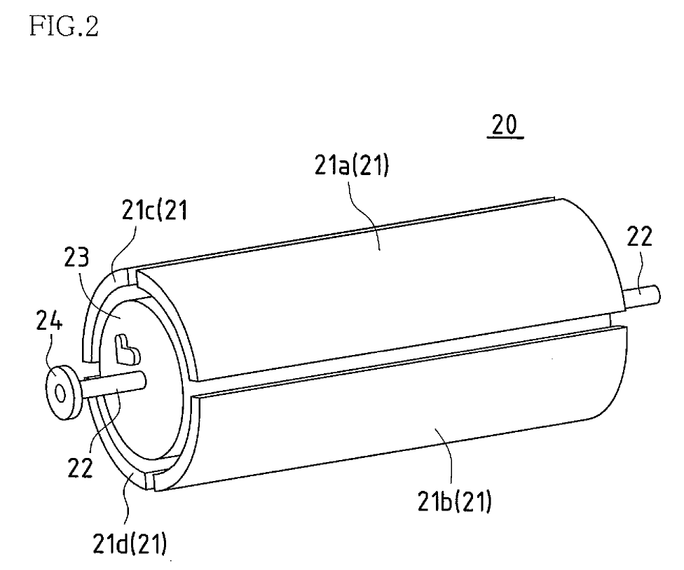

Next is a description of a printed wiring board manufacturing apparatus and printed wiring board manufacturing method used to form the printed wiring board 10 according to Embodiment 1, with reference to FIGS. 2 to 17D.

FIG. 2 is a perspective view that shows the general configuration of a drum unit serving as a constituent element of the printed wiring board manufacturing apparatus according to Embodiment 2 of the present invention.

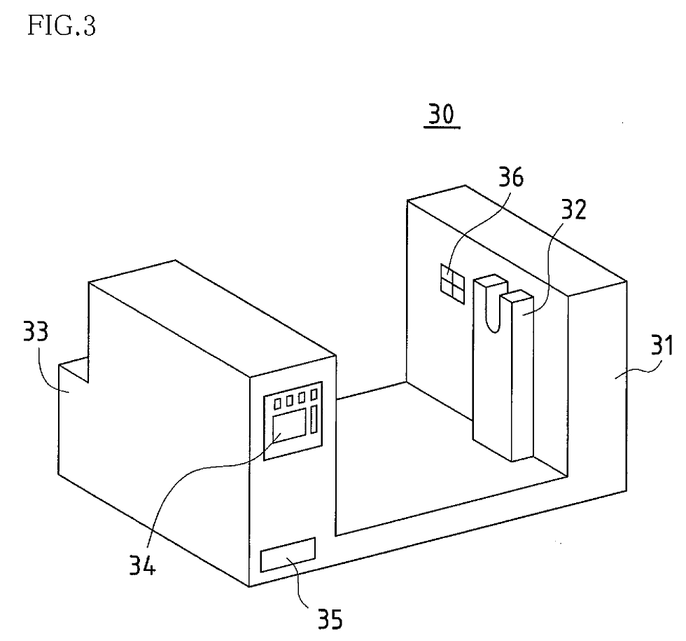

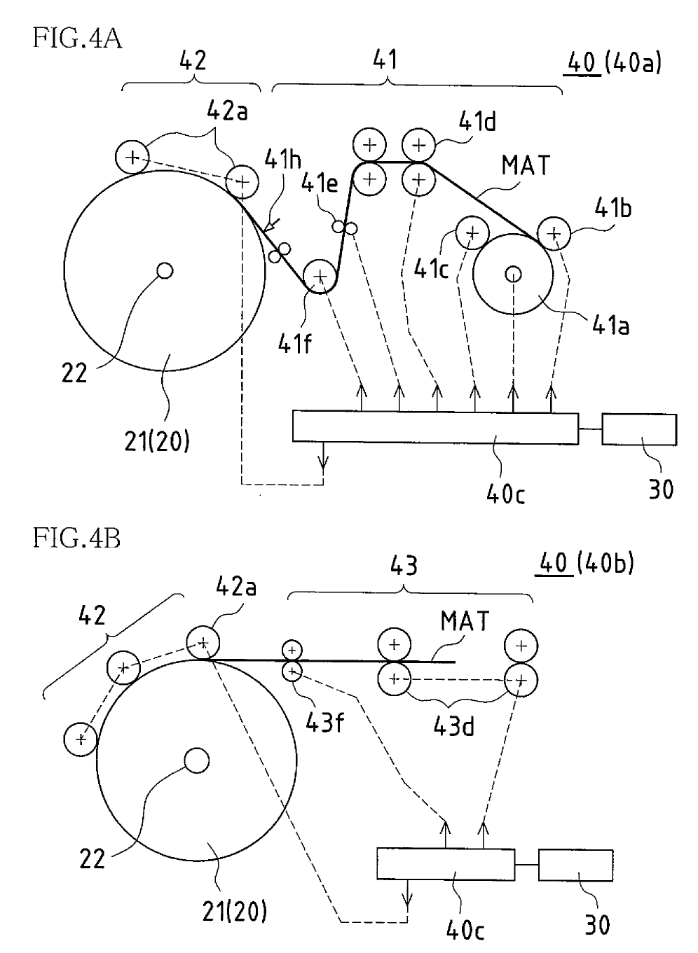

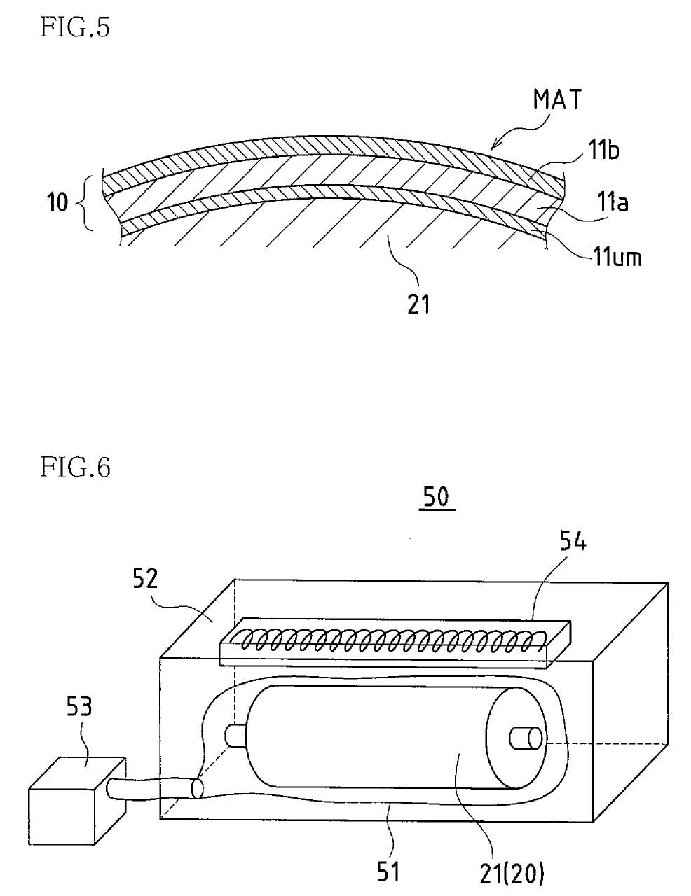

A drum unit 20 serving as a constituent element of the printed wiring board manufacturing apparatus is provided with a processing cylinder 21, a rotational shaft 22, and a drive linking portion 24. The processing cylinder 21 constitutes a cylindrical outer circumference so as to function as a jig that holds a processing subject (printed wiring board material MAT that forms the printed wiring board 10; see FIGS. 4A, 4B, and 5; also includes a photosensitive resist or the like that, during processing, is layered, applied, and finally removed) in a manufacturing step (a processing step) of manufacturing the printed wiring board 10 (see Embodiment 1; also, referred to as the printed wiring board 10 even in the midst of the processing step). The rotational shaft 22 rotationally drives the processing cylinder 21, and the drive linking portion 24 is linked to a rotational drive unit 30 (see FIG. 3) that is linked to and drives the rotational shaft 22.

The processing cylinder 21 is a cylinder made of a metal such as steel, stainless steel, or the like, and in order to improve processing precision, and in order to allow the printed wiring board 10 to be easily removed from the drum unit 20 after processing in which the drum unit 20 is applied is finished, the surface of the processing cylinder 21 is polished to a mirror finish. Also note that the processing cylinder 21 is configured to have a radius that is about the same as the inner radius of the printed wiring board 10 after processing has ended.

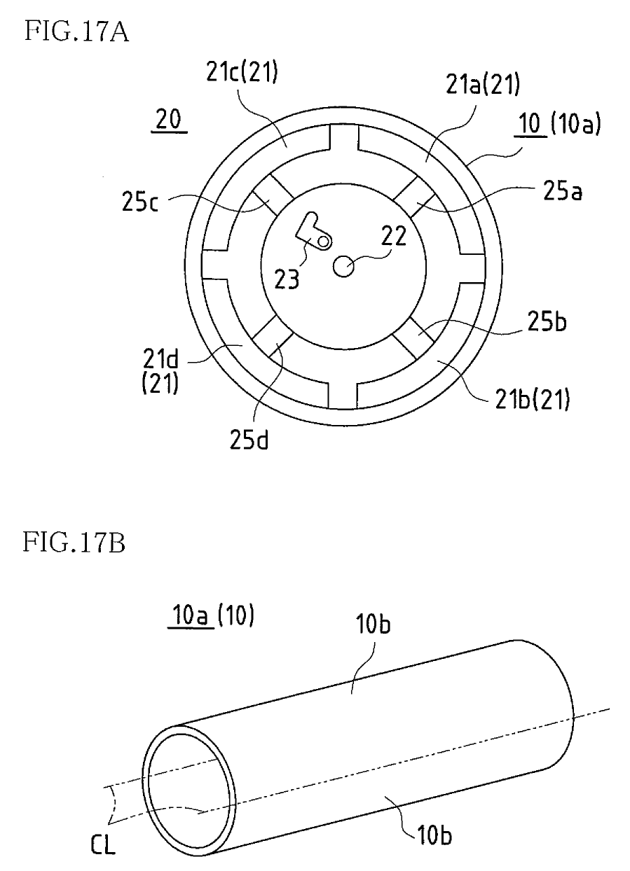

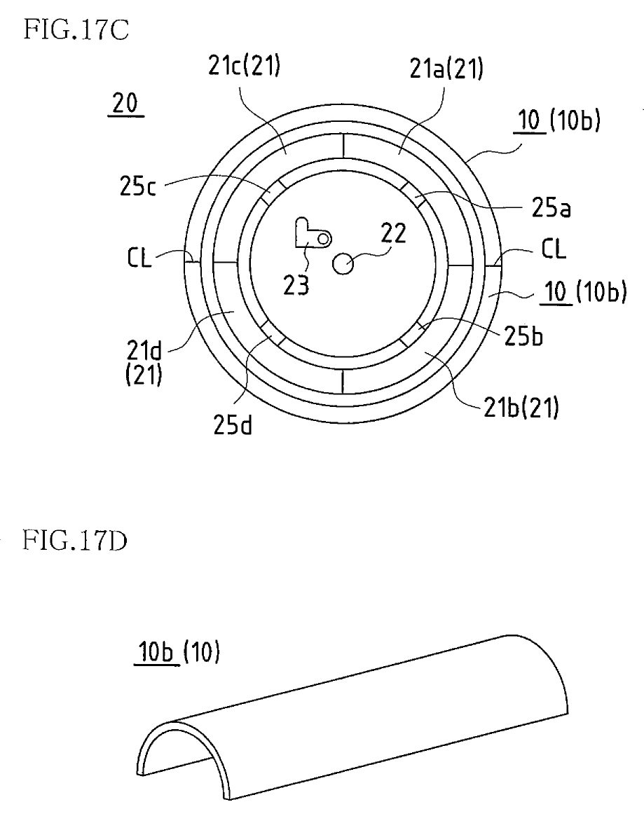

The processing cylinder 21 is configured from processing jig plates 21a, 21b, 21c, and 21d divided by n in the outer circumferential direction (n is an integer of 2 or greater; in the present Embodiment n=4 so there are four divisions). The processing jig plates 21a to 21d are separated from each other by a slight gap, and are respectively linked to the rotational shaft 22 by plate linking portions 25a, 25b, 25c, and 25d. (see FIG. 17).

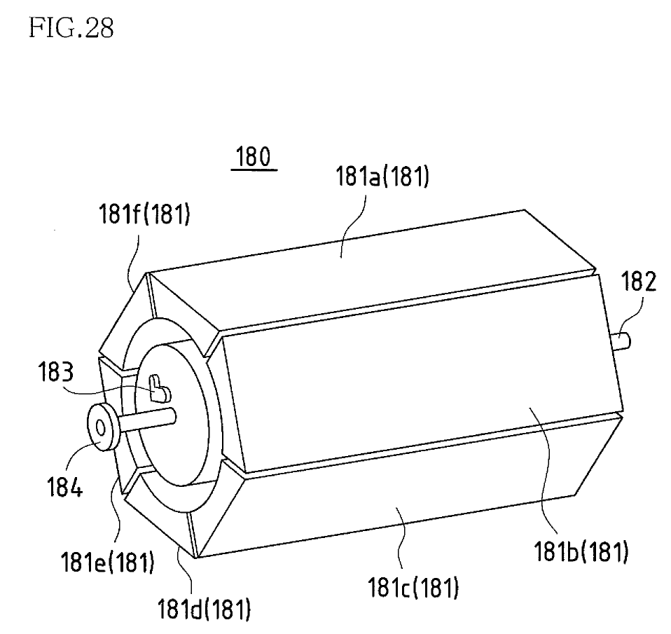

The processing cylinder 21 is shown having a cylindrical shape, but may also have the shape of a polygonal pillar in which a cross-section has a polygonal shape in a direction that intersects the rotational shaft 22 (Embodiment 12; see FIG. 28). Also, in the present specification it is presumed that a cylindrical shape encompasses a pillar-like shape having a thickness in the radial direction such that the pillar-like shape can be caused to function in the same manner as a cylindrical shape. With this configuration, it is possible for the processing cylinder 21 to be made suitable for the printed wiring board 10 serving as the processing subject, so high precision and efficient processing is possible.

The processing jig plates 21a to 21d have a configuration such that their position in the radial direction centered on the rotational shaft 22 is changed by operation of a radial control lever 23, and thus it is possible to change the radius of the outer circumference of the cylinder configured by the surface of the processing cylinder 21 (the processing jig plates 21a to 21d). Specifically, a configuration is adopted in which it is possible to change the radius from the rotational shaft 22 in a range of several tens of μm to several tens of mm where control is necessary in the manufacturing steps of manufacturing the printed wiring board 10.

The range of several tens of μm to several tens of mm used as the range of change in the radius of the outer circumference of the cylinder, on the entire circumference of the cylindrical printed wiring board 10 for which processing is finished, corresponds to an amount of displacement necessary to separate the printed wiring board 10 from the processing cylinder 21 (the processing jig plates 21a to 21d), and is also influenced by the pliability of the printed wiring board 10 that is formed. That is, this is a range prescribed in order to easily remove the printed wiring board 10 for which processing is finished from the drum unit 20, without making the movable range greater than necessary.

The rotational shaft 22 rotates according to rotational driving of the drive linking portion 24 that links to the rotational drive unit 30, so the rotational shaft 22 rotates the processing cylinder 21 (the processing jig plates 21a to 21d) at the rotational velocity of the drive linking portion 24. That is, it is possible to rotate the printed wiring board material MAT at a predetermined rotational velocity to perform necessary processing.

The drum unit 20 (the processing cylinder 21) is desirably provided with a temperature adjustment mechanism (not shown) in the internal space of the cylinder. A temperature adjustment mechanism can be provided directly or indirectly in the internal space of the inner back face of the processing jig plates 21a to 21d. By providing a temperature adjustment mechanism, the printed wiring board material MAT mounted to the processing jig plates 21a to 21d can be placed in an appropriate temperature state, and in a state suitable for processing, high precision and efficient processing is possible.

Also, the temperature adjustment mechanism can have heating or cooling functions, and can have a configuration provided with either or both of those functions. Also, heating or cooling can be performed electrically or electronically by supplying electric current, or can be performed by supplying a fluid (a gas or a liquid).

When performing temperature adjustment by supplying electric current, it is possible to perform heating or cooling by supplying electrical current from outside of the drum unit 20 via the rotational shaft 22 to an electrothermal transducer (for example, a Peltier effect element) used to configure the temperature adjustment apparatus. By applying an appropriate electrothermal transducer, it is possible to switch between heating and cooling by switching the direction of the electrical current. Also, when only heating with electric current, it is possible to perform simply resistive heating. With temperature control by electric current, it is possible to perform temperature adjustment by controlling the electric current, so the temperature adjustment can be performed easily and with high precision.

When performing temperature adjustment by supplying fluid (a gas or liquid such as a refrigerant or a heating medium), it is necessary to configure an appropriate circulation pipe path (not shown) in the cylinder space that allows circulation of the fluid supplied from outside of the drum unit 20. The circulation tube path can be appropriately configured by providing a joint that connects a narrow tube disposed inside the drum unit 20 and a supply tube from an external liquid supply source (heating medium supply source/refrigerant supply source) at a side face of the drum unit 20 in the shaft direction or within the rotational shaft 22. That is, by configuring an appropriate circulation tube path, it is possible to comparatively easily supply fluid from an externally disposed heating medium supply source/refrigerant supply source, and thus to efficiently perform heating/cooling.

The drum unit 20 (the processing cylinder 21) is desirably provided with an ultrasonic vibrator (not shown) in the internal space of the cylinder. By disposing the ultrasonic vibrator in contact with the inner circumferential back face of the processing cylinder 21, it is possible to cause the surface of the processing cylinder 21 to vibrate and thus increase processing efficiency for the printed wiring board material MAT, with the result that it is possible to perform processing with high precision. Also, electric current can be appropriately supplied to the ultrasonic vibrator from outside of the drum unit 20 via the rotational shaft 22.

FIG. 3 is a perspective view that shows the general configuration of a rotational drive unit serving as a constituent element of the printed wiring board manufacturing apparatus according to Embodiment 2 of the present invention.

The rotational drive unit 30 serving as a constituent element of the printed wiring board manufacturing apparatus is configured to rotationally drive the drum unit 20. With this configuration, it is possible to process the printed wiring board material MAT by controlling rotation of the drum unit 20, and thus it is possible to perform processing in which the outer circumference of the cylinder of the processing cylinder 21 is effectively utilized.

The rotational drive unit 30 is provided with a frame 31 serving as a basic structural body. The frame 31 is provided with a shaft bearing 32 that axially supports the rotational shaft 22. Also, a drive control portion 33 that is linked to the drive linking portion 24 and rotationally drives the drum unit 20 (the processing cylinder 21) is provided at a position of the frame 31 that faces shaft bearing 32. The drum unit 20 and the rotational drive unit 30 are configured to be removable as necessary.

The drive control portion 33 is provided with a rotation detection mechanism 36 for detecting the rotational velocity and rotation angle of the processing cylinder 21, and a control mechanism for controlling the rotational velocity and rotation angle, and the drive control portion 33 is configured to control the positional state and the rotational state of the processing cylinder 21 so that processing can be performed on the processing cylinder 21 in a manufacturing step (a processing step) of manufacturing the printed wiring board 10.

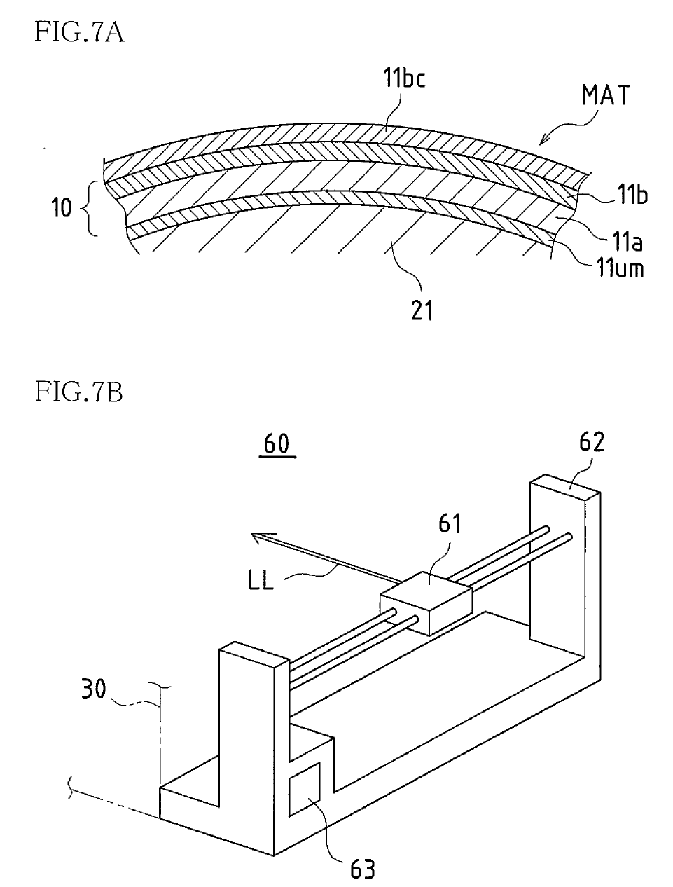

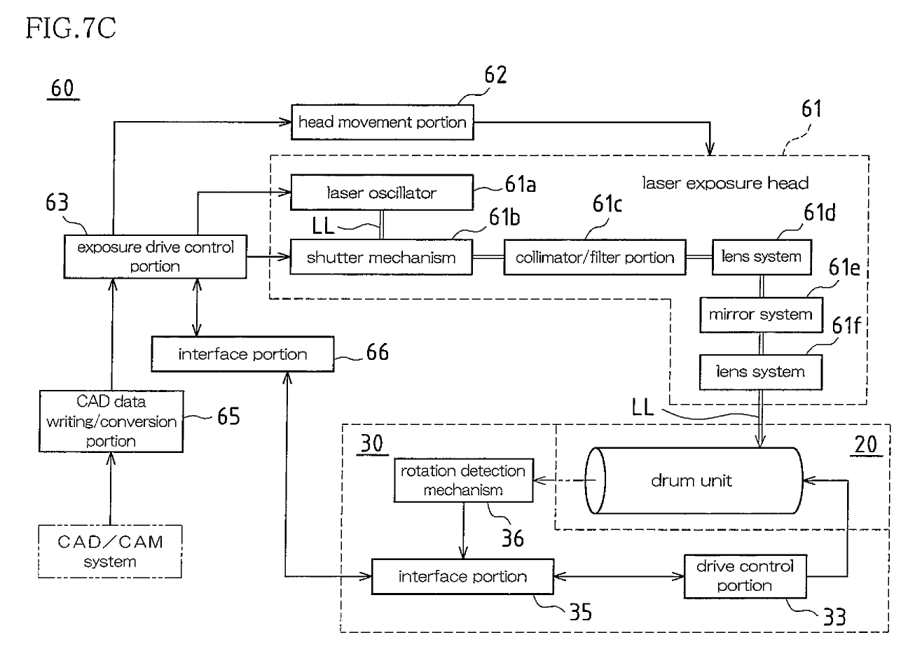

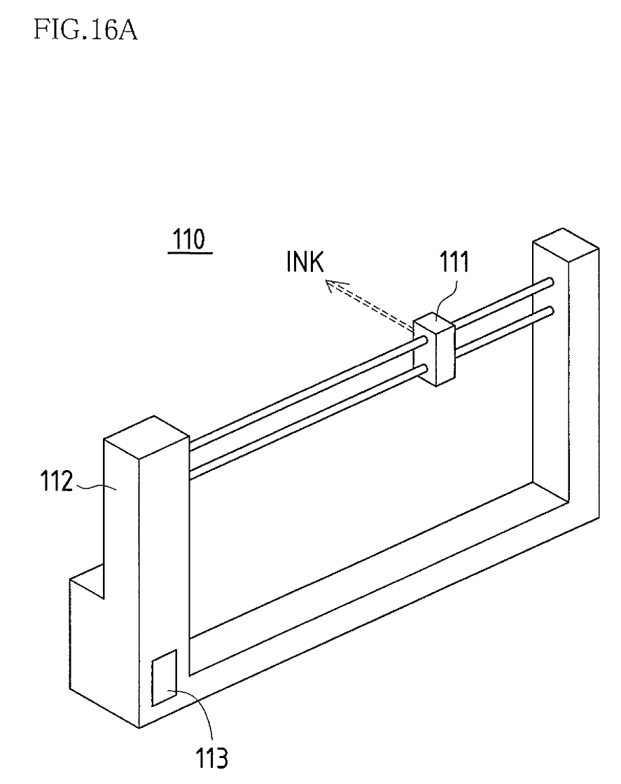

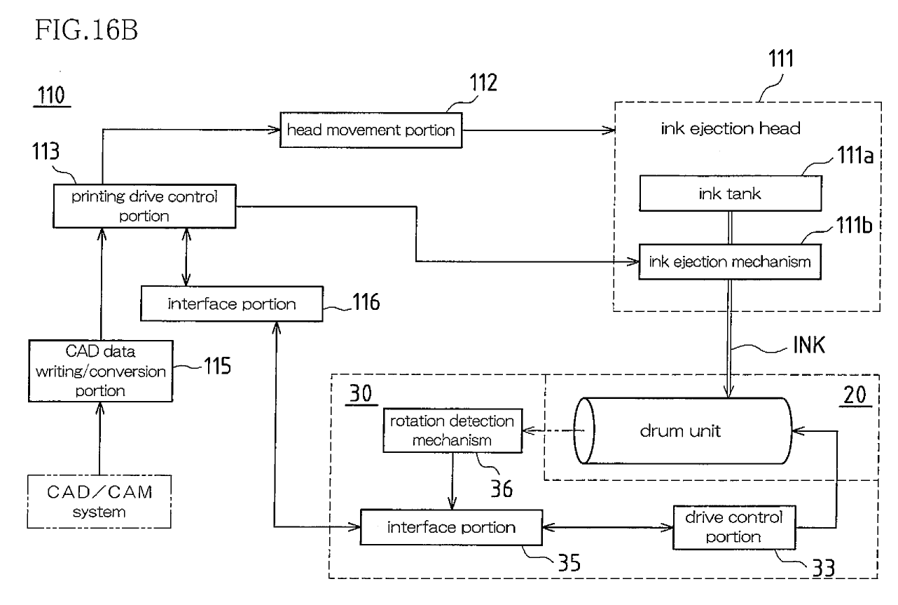

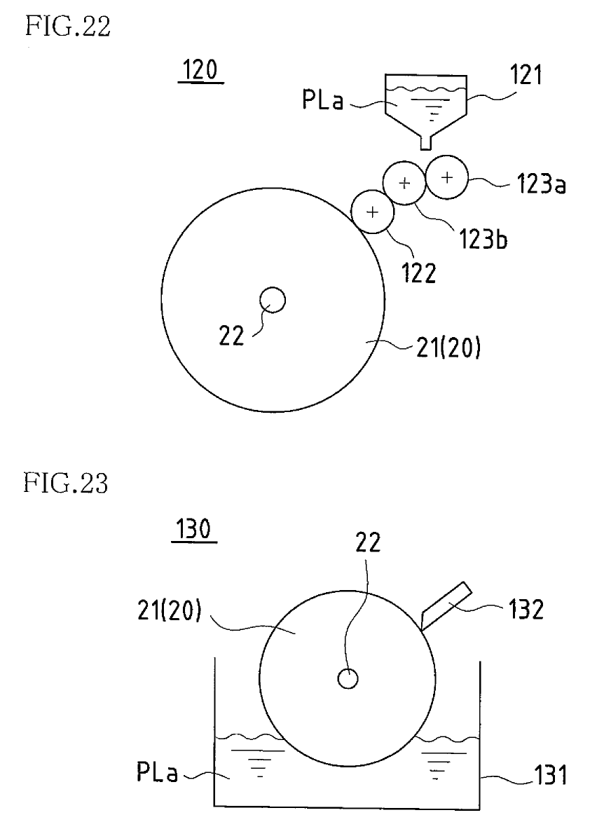

The drive control portion 33 is further provided with a control panel 34 that receives instruction input from outside in order to adjust the specifications or the like of the detection mechanism and the control mechanism, and an interface portion 35 for coordinating with an external portion. More specifically, the drive control portion 33 is provided with a signal processing portion, an interface, and the like linked to various processing units 40 (FIGS. 4A, 4B), 60 (FIGS. 7B and 7C), 110 (FIGS. 16A and 16B), 120 (FIG. 22), 180 (FIG. 28), and the like described below, with the signal processing portion performing signal processing in order to give and receive signals of an appropriate rotational velocity, rotation angle and the like.

An interface portion 35, when processing is executed by a processing unit 40 or the like, is connected to the processing unit 40 or the like, and receives control data from the processing unit 40 or the like. The control data is, for example, information related to the rotational position, rotational velocity, rotation angle, standard position, and rotation synchronization of the processing cylinder 21 necessary when the processing unit 40 or the like performs processing. The drive control portion 33 controls rotation (aspects of rotation such as rotational position, rotational velocity, rotation angle, standard position, and rotation synchronization) of the processing cylinder 21 based on the control data received by the interface portion 35, adapted to the processing unit 40 or the like, and thus efficient and high precision processing in coordination with the processing unit 40 or the like can be performed.

That is, because rotational drive unit 30 is provided with the drive control portion 33 and the interface portion 35, the rotational drive unit 30 can perform processing in coordination with the processing unit 40 or the like efficiently and with high precision by controlling the rotation of the processing cylinder 31. Also, due to appropriate instructions being input to the control panel 34, it is possible to perform adjustment more effectively and with higher precision.

FIGS. 4A and 4B are side views that conceptually show the general configuration of a film layering unit that is one example of a processing unit serving as a constituent element of the printed wiring board manufacturing apparatus according to Embodiment 2 of the present invention. FIG. 4A shows a film layering unit in which a roll-like printed wiring board material is applied, and FIG. 4B shows a film layering unit in which a sheet-like printed wiring board material is applied.

First, a state is established in which the drum unit 20 is rotatable by mounting the drum unit 20 to the rotational drive unit 30, and then the film layering unit 40 (also referred to as the processing unit 40) serving as a processing unit is linked to the rotational drive unit 30, and the printed wiring board manufacturing apparatus is configured (not shown). That is, this is a cylinder preparation step of preparing the processing cylinder 21 on which the printed wiring board material MAT is layered. Below, preparation of the processing cylinder 21 is a similar cylinder preparation step, and so a description thereof is omitted as appropriate.

The film layering unit 40 (40a) shown in FIG. 4A is provided with a roll material supply mechanism 41 that supplies the printed wiring board material MAT rolled up into a roll to the processing cylinder 21 in a state maintaining tension of the printed wiring board material MAT, and a pressing mechanism 42 that applies pressure to the printed wiring board material MAT supplied to the processing cylinder 21. The film layering unit 40 (40a) is configured to layer the printed wiring board material MAT on the processing cylinder 21. With this configuration, it is possible to layer (affix) the printed wiring board material MAT rolled up into a roll, by continuously supplying the printed wiring board material MAT rolled up into a roll and pressing that material to the processing cylinder 21.

The roll material supply mechanism 41 is provided with a roll material supply roller 41a where the printed wiring board material MAT has been rolled up into a roll, a roll material feed-out roller 41b that feeds out the printed wiring board material MAT from the roll material supply roller 41a, a backup roller 41c for preventing the printed wiring board material MAT from unnecessarily coming loose, a feed roller 41d that supplies the printed wiring board material MAT, a guide roller 41e placed in an unreeling path of the printed wiring board material MAT, and a tension roller 41f that provides a fixed tensile force to the printed wiring board material MAT.

The pressing mechanism 42 is provided with a pressure roller 42a that applies pressure to affix the printed wiring board material MAT supplied to the processing cylinder 21 onto the surface of the processing cylinder 21 (alternatively, an underlayer of the printed wiring board material MAT that has been previously laminated).

The film layering unit 40 is provided with a layering control portion 40c that controls driving of the roll material supply mechanism 41 and the pressing mechanism 42. Also, the layering control portion 40c is configured so that the amount of control performed with the layering control portion 40c is adjusted by sending and receiving signals to and from the rotational drive unit 30 via the interface portion 35. A configuration is adopted such that the printed wiring board material MAT is appropriately cut by a cutting mechanism 41h disposed in a border area of the roll material supply mechanism 41 and the pressing mechanism 42.

The film layering unit 40 (40b) shown in FIG. 4B is provided with a sheet material supply mechanism 43 that supplies sheet-like printed wiring board material MAT, that has been cut to an appropriate size corresponding to the processing cylinder 21, to the processing cylinder 21 in a state maintaining tension of the printed wiring board material MAT, and a pressing mechanism 42 that applies pressure to the printed wiring board material MAT supplied to the processing cylinder 21. The film layering unit 40 (40b) is configured to layer the printed wiring board material MAT on the processing cylinder 21. With this configuration, it is possible to layer (affix) the sheet-like printed wiring board material MAT by supplying the sheet-like printed wiring board material MAT and pressing that material to the processing cylinder 21.

The sheet material supply mechanism 43 is provided with a feed roller 43d that feeds out the printed wiring board material MAT, and a tension roller 43f that provides a fixed tensile force to the printed wiring board material MAT. As for other differences with the film layering unit 40 shown in FIG. 4A, except for the roll material supply roller 41a, the roll material feed-out roller 41b, and the backup roller 41c, which are omitted, the basic configuration of the film layering unit 40 shown in FIG. 4B is the same, and so a detailed description thereof is omitted here.

When the printed wiring board material MAT has photosensitivity, a configuration is adopted in which the printed wiring board manufacturing apparatus that processes the printed wiring board material MAT is provided with a box-like light-blocking mechanism (not shown) that encloses the entire printed wiring board manufacturing apparatus, including the film layering unit 40 and the drum unit 20, in order to block external light from the printed wiring board material MAT. For example, it is possible to realize a very good light blocking mechanism by covering a position where light blocking of the printed wiring board manufacturing apparatus is necessary (for example, the film layering unit 40 and the drum unit 20) with a blackout curtain. With this configuration, it is possible for printed wiring board material MAT having photosensitivity to be supplied to the processing cylinder 21 and layered very easily, and possible to easily and precisely perform necessary exposure treatment.

Next is a description of an example of a case in which printed wiring board material has been layered using the film layering unit 40.

FIG. 5 is a cross-sectional view that shows the cross-sectional state of an example printed wiring board obtained by layering printed wiring board material on a processing cylinder using the film layering unit shown in FIGS. 4A and 4B.

First, a metal underlayer 11um that functions as an underlayer layered on the printed wiring board material MAT is placed in the film layering unit 40, Next, the film layering unit 40, the rotational drive unit 30, and the drum unit 20 are operated in coordination with each other and thus the printed wiring board manufacturing apparatus enters an operating state. By wrapping the metal underlayer hum around the entire outer circumferential face of the processing cylinder 21 and mechanically pressing the metal underlayer 11um against that face, or alternatively by pinching an end portion of the metal underlayer hum with a clamp mechanism, the metal underlayer hum is fixed (layered).

When necessary, a material that aids in fixing such as an adhesive may be inserted between the surface of the processing cylinder 21 and the metal underlayer 11um. Adhesive can be easily employed by appropriately applying the adhesive to (all or a portion of) the back face of the metal underlayer 11um in advance.

A configuration is adopted in which at the end of processing with the drum unit 20, the metal underlayer 11um can be easily peeled away from the surface of the processing cylinder 21. For example, it is possible to employ a method such as applying a thermoplastic resin that softens at a low temperature to an end portion of the metal underlayer 11um, or a method in which a very thin film of thermosetting resin is provided, and when peeling that film away, a state is established such that the film is easily split and peeled away.

Because the metal underlayer hum is ultimately (after the printed wiring board 10 is removed from the processing cylinder 21) removed by etching, it is desirable to select a metal than can be easily removed by etching. For example, it is possible to use aluminum foil, stainless steel foil, copper foil, nickel foil, or the like. In the present example, copper is used as a conductor of the printed wiring board 10, and aluminum foil is used for the metal underlayer hum because thus selective etching of the copper is possible.

After the metal underlayer 11um has been layered, a substrate insulating resin layer 11a serving as printed wiring board material MAT used to configure a wiring substrate (insulating substrate) positioned on a concave face side of the printed wiring board 10 is placed in the film layering unit 40. Next, the film layering unit 40, the rotational drive unit 30, and the drum unit 20 are operated in coordination with each other and thus the printed wiring board manufacturing apparatus enters an operating state. The substrate insulating resin layer 11a is supplied to the processing cylinder 21, and the substrate insulating resin layer 11a is layered on (affixed to) the entire surface of the previously layered metal underlayer 11um. That is, this is a material layering step of layering the printed wiring board material MAT on the processing cylinder 21 (hereinafter, other material layering is performed in the same material layering step, and so a description thereof is omitted as appropriate). The material layering step is one form of processing step.

In the present example, a commercially available prepreg is used as the substrate insulating resin layer 11a. In the commercially available prepreg, an epoxy resin mainly in a semi-hardened state is mixed into a glass cloth. In the present embodiment, the material used as the printed wiring board material MAT is basically unlimited; the printed wiring board material MAT can be selected from material for printed wiring board manufacture that is ordinarily commercially available, in consideration of necessary characteristics as appropriate.

For example, as the substrate insulating resin layer 11a, instead of a prepreg, many materials that are conventionally used as insulating resin of a printed wiring board can be used, such as polyimide film or polyether ketone, polyester, fluorocarbon resin, or other liquid crystal polymers.

After the substrate insulating resin layer 11a has been layered, on the substrate insulating resin layer 11a, a first conductor layer 11b is likewise layered as printed wiring board material MAT that becomes a conductor layer that is a second layer viewed from the surface (outside) of the convex face side of the printed wiring board 10. That is, this is a material layering step of layering printed wiring board material MAT on the processing cylinder 21.

In the present example, copper foil with a thickness of 18 μm is used as the first conductor layer 11b. A configuration may also be adopted in which the prepreg (the substrate insulating resin layer 11a) and the copper foil (the first conductor layer 11b) are not layered separately, rather, resin coated copper (RCC) on which copper foil is layered is used from the beginning.

During layering processing or when temporarily stopped, by appropriately heating the surface of the processing cylinder 21 and the printed wiring board material MAT using a temperature adjustment mechanism (not shown; see FIG. 2) provided in the cylindrical internal space of the processing cylinder 21, it is possible to improve adhesiveness and affinity to the surface.

After layering the metal underlayer 11um, the substrate insulating resin layer 11a, and the first conductor layer 11b, the film layering unit 40 (the drum unit 20) is removed from the rotational drive unit 30.

FIG. 6 is a transparent perspective view that conceptually shows the transparently viewed general configuration of a vacuum press unit that is one example of a processing unit serving as a constituent element of the printed wiring board manufacturing apparatus according to Embodiment 2 of the present invention.

A vacuum press unit 50 (also referred to as a processing unit 50) serving as a processing unit performs processing to apply heat and pressure to the metal underlayer hum layered on the processing cylinder 21, and the substrate insulating resin layer 11a and the first conductor layer 11b serving as the printed wiring board material.

The vacuum press unit 50 is provided with a vacuum bag 51 that houses the processing cylinder 21 (the drum unit 20) as a processing subject, a heating chamber 52 that houses and heats the vacuum bag 51, a depressurizing apparatus 53 that depressurizes the vacuum bag 51 by evacuating air from the vacuum bag 51, and a heating apparatus 54 that performs heating inside the heating chamber 52. That is, the vacuum press unit 50 is provided with fundamentally the same structure as an ordinary vacuum press apparatus.

First, the processing cylinder 21 is removed from the rotational drive unit 30 and stored in the vacuum bag 51. Next, the vacuum bag 51 in which the processing cylinder 21 is stored is stored in the heating chamber 52, and after depressurizing with the depressurizing apparatus 53, heat is applied by the heating apparatus 54. Also note that the heating chamber 52 is provided with an appropriate pedestal (not shown) that holds the vacuum bag 51 in which the processing cylinder 21 is stored.

With the processing to apply heat and pressure by the vacuum press unit 50, heat and pressure are applied to the metal underlayer hum, the substrate insulating resin layer 11a, and the first conductor layer 11b layered on the processing cylinder 21, so that the substrate insulating layer 11a in a semi-hardened state is hardened, and affixed to the metal layers (the metal underlayer hum and the first conductor layer 11b) above and below the substrate insulating resin layer 11a. That is, press processing (fixing processing) can be performed on the metal underlayer 11um, the substrate insulating resin layer 11a, and the first conductor layer 11b layered on the processing cylinder 21.

In the press processing step, it is possible to shorten the processing time by not only heating with the vacuum press unit 50, but also operating the temperature adjustment mechanism disposed in the internal cylindrical space of the processing cylinder 21 (the drum unit 20), thus further increasing the heating speed, or alternatively, swiftly cooling by cooling the processing cylinder 21 after press processing.

The printed wiring board 10 after the press processing step has the same configuration as the cross-section shown in FIG. 5.

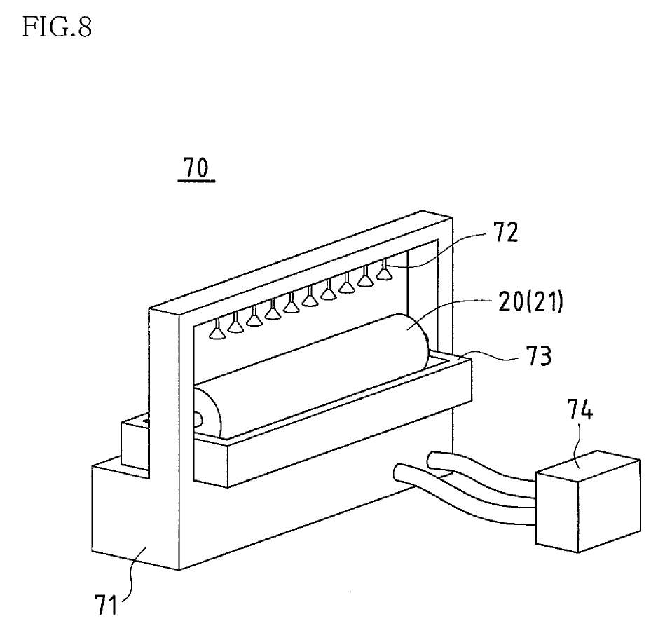

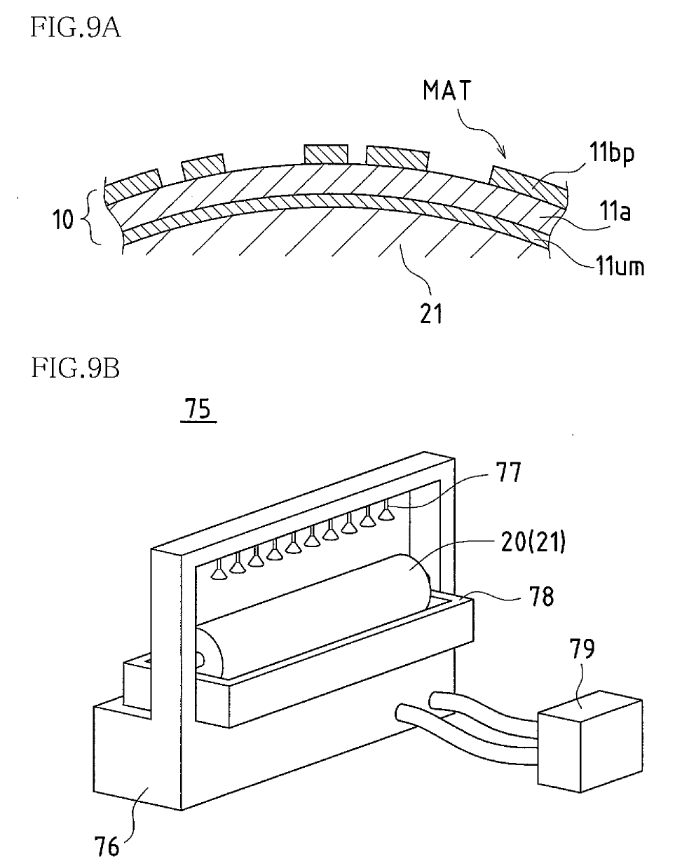

Next, a state in which a first conductor layer pattern 1bp (see FIG. 9A) serving as a wiring pattern in which photolithography technology is applied to the first conductor layer 11b will be described with reference to FIGS. 7A, 7B, 7C, and 8.

FIG. 7A is a cross-sectional view that shows the cross-sectional state of the printed wiring board shown in FIG. 5, in a state with an etching resist film formed as printed wiring board material in the first conductor layer. FIG. 7B is a perspective view that conceptually shows the general configuration of a laser exposure unit that is one example of a processing unit serving as a constituent element of the printed wiring board manufacturing apparatus according to Embodiment 2 of the present invention. FIG. 7C is a block diagram that shows the block configuration of the laser exposure unit shown in FIG. 7B.

After performing processing to apply heat and pressure to the metal underlayer 11um, the substrate insulating resin layer 11a, and the first conductor layer 11b that have been layered, the drum unit 20 (the processing cylinder 21) is installed to the rotational drive unit 30, and thus again linked to the film layering unit 40 (see FIGS. 4A and 4B).

Employing the film layering unit 40, an etching resist film 11bc composed of photosensitive resin, which is a so-called dry film, is layered on the surface of the first conductor layer 11b (FIG. 7A). That is, this is a material layering step of layering printed wiring board material MAT on the processing cylinder 21.

The etching resist film 11bc is photosensitive, and so a light-blocking mechanism (same as the light-blocking mechanism described above) that blocks the etching resist film 11bc from external light is provided to appropriately block light in the printed wiring board manufacturing apparatus (the film layering unit 40 and the drum unit 20).

The film layering unit 40 is removed from the rotational drive unit 30, and instead a laser exposure unit 60 (also referred to as a processing unit 60; see FIG. 7B) serving as a processing unit is made to correspond to the drum unit 20, and is linked to (placed in) the rotational drive unit 30 in which the drum unit 20 is installed.

The laser exposure unit 60 is provided with a laser exposure head 61 that, irradiates a laser beam LL synchronized with rotation of the processing cylinder 21 onto printed wiring board material MAT (the etching resist film 11bc) that has been layered on the surface of the processing cylinder 21, a head movement portion 62 that moves the laser exposure head 61 parallel to the rotational shaft 22, and an exposure drive control portion 63 that drives and controls the laser exposure head 61 and the head movement portion 62.

With this configuration, it is possible to employ the laser beam LL to perform exposure, and possible to perform laser exposure efficiently and with high precision. That is, this is a processing step of performing processing (laser exposure treatment) on the printed wiring board material MAT layered on the processing cylinder 21. Below, other processing is performed in a similar processing step, and so a description thereof is omitted as appropriate.

The laser beam LL irradiated on the photosensitive etching resist film 11bc formed on the surface of the processing cylinder 21 is configured to have an energy and a wavelength that exposes the etching resist film 11bc.

Also, the laser exposure unit 60 (the laser exposure head 61) is provided with a laser oscillator 61a serving as a laser light source, a shutter mechanism 61b, a collimator/filter portion 61c, a lens system 61d that adjusts luminous flux of the laser beam LL, and a tip optical system (a mirror system 61d and a lens system 61f) for irradiating a laser beam LL of a necessary spot diameter on the face of an exposure subject, and the like (FIG. 7C).

A configuration is also possible in which the laser oscillator 61a, the shutter mechanism 61b, the collimator/filter portion 61c, and the lens system 61d that adjusts luminous flux of the laser beam LL are disposed outside of the laser exposure head 61.

The laser exposure head 60 (the exposure drive control portion 63) is connected via the interface portion 35 and an interface portion 66 to the rotation detection mechanism 36, which is configured with a linear encoder that detects an exposure position, and is also connected to a CAD/CAM system via a CAD data writing/conversion portion 65. The CAD data writing/conversion portion 65 converts CAD data received from the CAD/CAM system to exposure data and inputs the converted data to the exposure drive control portion 63 (FIG. 7C).

The exposure drive control portion 63 controls the laser oscillator 61a, the shutter mechanism 61b, and the head movement portion 62. Accordingly, the laser exposure unit 60 is capable of confirming the rotational position of the processing cylinder 21, which rotates according to the rotational drive unit 30, based on signals from the rotational drive unit 30, and is capable of moving the laser exposure head 61 in the axial direction of the rotational shaft 22.

Also, the laser exposure head 61 irradiates the laser beam LL so as to expose the etching resist film 11bc according to exposure data corresponding to the first conductor layer pattern 11bp generated according to circuit pattern data serving as CAD data.

After finishing exposure of the etching resist film 11bc to the laser beam LL, the laser exposure unit 60 and the drum unit 20 are removed from the rotational drive unit 30.

FIG. 8 is a perspective view that conceptually shows the general configuration of a development unit that is one example of a processing unit serving as a constituent element of the printed wiring board manufacturing apparatus according to Embodiment 2 of the present invention.

A development unit 70 (also referred to as a processing unit 70) that serves as a processing unit performs development treatment on photosensitive resin (the etching resist film 11bc) that has been exposed by the laser exposure unit 60. That is, this is a processing step of performing processing on the printed wiring board material MAT layered on the processing cylinder 21. It is possible to perform pattern formation of the etching resist film 11bc by performing a series of development treatments such as development with a development fluid, accompanying rinsing, and resist hardening.

The development unit 70 is provided with a rotational drive portion 71 that axially supports and rotationally drives the drum unit 20, a shower mechanism 72 that serves as a development treatment fluid supply portion that supplies to the processing cylinder a treatment fluid for development such as a development fluid, a washing fluid (purified water), or the like, and an accumulation tank 73 that accumulates treatment fluid that has been supplied. With this configuration, it is possible to easily and precisely develop and wash photosensitive resin that has been exposed in a state layered on a processing cylinder.

Also, the development unit 70 is provided with a control portion 74 that performs centralized control of other constituent elements necessary for development treatment (a development fluid tank, washing fluid tank, development fluid circulation pump, washing fluid supply pump, fluid concentration management mechanism, filters, pipes, or other constituent elements). The shower mechanism 72 is capable of further improving the development precision by swinging a shower nozzle that supplies treatment fluid in a shower-like manner.

The development unit 70 can also be a simplified development unit. That is, a configuration can be adopted in which the drum unit 20 is installed in the rotational drive unit 30, and the development unit 70 is a simplified development unit (not shown) that serves as a processing unit configured by combining, in the rotational drive unit 30, the shower mechanism 72 as a development fluid supply portion, and the accumulation tank 73 that accumulates the supplied development fluid. With this configuration, it is possible to easily and precisely develop and wash photosensitive resin that has been exposed in a state layered on the processing cylinder 21, using a simplified processing unit in which the rotational drive portion 71 of the development unit 70 is omitted.

In the case of a configuration employing a simplified development unit, while rotating the drum unit 20 with the rotational drive unit 30, development treatment fluid such as development fluid, washing fluid, or the like is showered on the drum unit 20, thus performing development and washing of the photosensitive resin (the etching resist film 11bc) affixed to the surface of the drum unit 20. Also, although it is necessary to match the structure of the shower mechanism 72, the accumulation tank 73, and the like to the structure of the rotational drive unit 30, such a configuration has the advantage that it is possible to simplify the mechanism portion because the rotational drive portion 71 can be omitted.

Drying after development, and curing of the etching resist film 11bc, can be performed with a heating/blowing unit obtained by incorporating heating and blowing units in the development unit 70. Also, this drying and curing can be performed on a suitable pedestal, or can be performed separately with a dedicated heating/blowing unit.

Also, a configuration is possible in which complete hardening is performed by, after exposure and development, in state with the drum unit 20 installed in the rotational drive unit 30, while rotating the drum unit 20, irradiating post-curing electromagnetic waves (ultraviolet rays (UV light), X-rays, or the like) to the etching resist film 11bc from an electromagnetic wave irradiation portion. A post-curing unit, which irradiates post-curing electromagnetic waves from the electromagnetic wave irradiation portion in a state with the drum unit 20 installed in the rotational drive unit 30, can be configured as a processing unit. Also, complete hardening can be performed also by heating.

FIGS. 9A and 9B are explanatory diagrams that illustrate a state in which a wiring pattern (a first conductor layer pattern) is formed by etching the printed wiring board material (first conductor layer) shown in FIG. 5. FIG. 9A is a cross-sectional diagram that shows the cross-sectional state of an example printed wiring board obtained by forming a wiring pattern (the first conductor layer pattern), and FIG. 9B is a perspective view that conceptually shows the general configuration of an etching unit that is one example of a processing unit serving as a constituent element of the printed wiring board manufacturing apparatus according to Embodiment 2 of the present invention.

After finishing development treatment (resist pattern formation) of the etching resist film 11bc formed on the surface of the printed wiring board 10, the patterned resist pattern (the first conductor layer pattern 11bp and the etching resist film 11bc with the same pattern are formed) is used as a mask, and a wiring pattern (the first conductor layer pattern 11bp) is formed by etching the first conductor layer 11b (FIG. 9A). That is, this is a processing step of performing processing on the printed wiring board material MAT layered on the processing cylinder 21.

Etching of the first conductor layer 11b is performed by placing the drum unit 20 in an etching unit 75 (FIG. 9B; also referred to as a processing unit 75) provided with a structure similar to that of the development unit 70. That is, the etching unit 75, like the development unit 70, is provided with a rotational drive portion 76 that axially supports and rotationally drives the drum unit 20, and a shower mechanism 77 that serves as an etching fluid supply portion that supplies etching fluid to the processing cylinder 21.

With this configuration, it is possible to easily and precisely perform etching on an etching subject in which a resist pattern has been formed in a state layered on a processing cylinder, and it is possible to maintain and improve the dimensional precision of printed wiring.

Also, the etching unit is provided with an accumulation tank 78 that accumulates supplied etching fluid, and a control portion 79 that performs centralized control of other constituent elements necessary for etching processing (an etching fluid tank, washing fluid tank, etching fluid circulation pump, washing fluid supply pump, fluid concentration management mechanism, filters, pipes, or other constituent elements).

Any etching fluid compatible with the metal forming the conductor layer (first conductor layer 11b) may be used, and in the present example, because copper is used as the first conductor layer 11b, cupric chloride and ferric chloride are used.

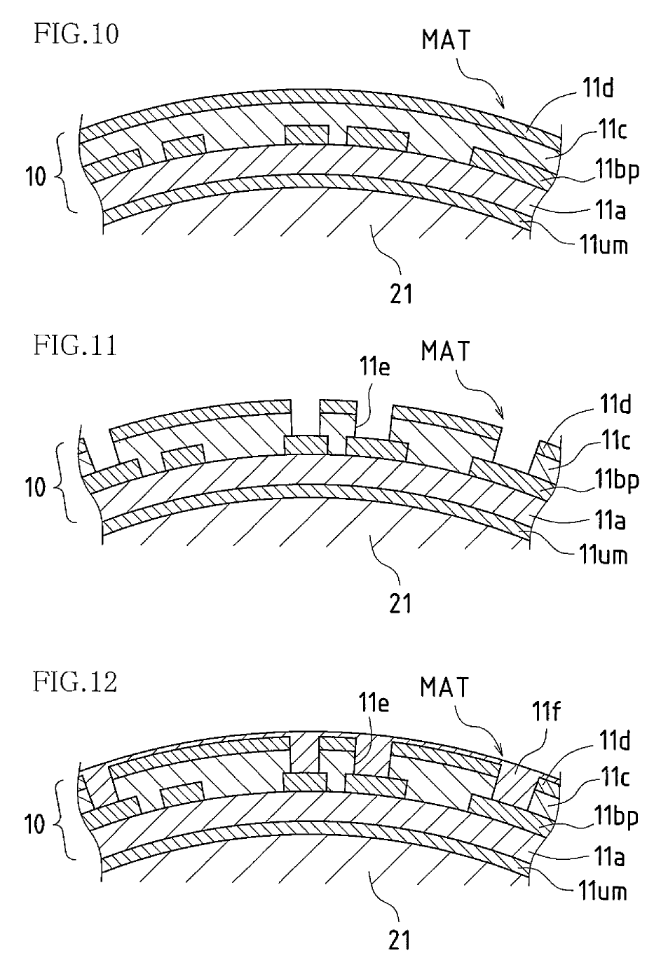

FIG. 10 is a cross-sectional diagram that shows the cross-sectional state of an example printed wiring board obtained by layering printed wiring board material (an interlayer insulating resin layer and a second conductor layer) on the first conductor layer pattern shown in FIG. 9A.

After the first conductor layer pattern 11bp is formed on the printed wiring board 10, an interlayer insulating resin layer 11c and a second conductor layer 11d are formed by layering on the surface of the first conductor layer pattern 11bp, using the film layering unit 40 and the vacuum press unit 50. That is, this is a material layering step of layering printed wiring board material MAT on the processing cylinder 21. The first conductor layer pattern 11bp and the second conductor layer 11d are insulated from each other by the interlayer insulating resin layer 11c.

The interlayer insulating resin layer 11c is desirably constituted from basically the same material as the substrate insulating resin layer 11a. For example, the interlayer insulating resin layer 11c can be constituted from fiberglass-reinforced epoxy resin, polyimide resin, or the like. In the present example, a commercially available prepreg is used that is semi-hardened fiberglass-reinforced epoxy resin, so the prepreg (the interlayer insulating resin layer 11c) and the copper foil (the second conductor layer 11d) are layered without adhesive in between.

Other than the above, it is possible to employ resin coated copper, and a configuration is possible in which copper film and insulating resin film are pasted together using an adhesive sheet.

FIG. 11 is a cross-sectional diagram that shows the cross-sectional state of an example printed wiring board in which a via hole is formed in the interlayer insulating resin layer and the second conductor layer shown in FIG. 10.

A via hole 11e is formed in the printed wiring board 10 in the interlayer insulating resin layer 11e and the second conductor layer 11d formed on the surface of the first conductor wiring pattern 11bp using a laser processing unit as a processing unit (The laser processing unit can be configured in the same manner as the laser exposure unit 60 (see FIGS. 7B and 7C), with only the laser wavelength and the beam intensity being different, so the laser processing unit is not shown). That is, this is a processing step of performing processing on printed wiring board material MAT layered on the processing cylinder 21.

The drum unit 20 is installed in the rotational drive unit 30, and the laser processing unit is linked to the rotational drive unit 30. The basic structure of the laser processing unit is the same as the laser exposure unit 60, and so a detailed description thereof is omitted here.

The laser processing unit is provided with a laser processing head that irradiates a laser beam synchronized with rotation of the processing cylinder 21 onto printed wiring board material MAT that has been layered on the surface of the processing cylinder 21, a head movement portion that moves the laser processing head parallel to the rotational shaft 22, and a processing drive control portion (corresponding to the exposure drive control portion 63) that drives and controls the laser processing head and the head movement portion.

The laser processing unit 60 (processing drive control portion), as described above, like the laser exposure unit 60, is provided with a laser oscillator serving as a laser light source, a shutter mechanism, a collimator/filter portion, a lens system that adjusts luminous flux of the laser beam LL, and a tip optical system (a mirror system and a lens system) for irradiating a laser beam LL of a necessary spot diameter on the face of an exposure subject, and the like.

Also, as above, the processing drive control portion is connected via the interface portion 35 to the rotation detection mechanism 36, which is configured with a linear encoder that detects a processing position, and is also connected to a CAD/CAM system via a CAD data writing/conversion portion. The CAD data writing/conversion portion converts CAD data received from the CAD/CAM system to processing data and inputs the converted data to the processing drive control portion.

The processing drive control portion controls the laser oscillator, the shutter mechanism, and the head movement portion. Accordingly, the laser processing unit is capable of confirming the rotational position of the processing cylinder 21, which rotates according to the rotational drive unit 30, based on signals from the rotational drive unit 30, and is capable of moving the laser processing head in the axial direction of the rotational shaft 22.

The laser processing unit basically differs from the laser exposure unit 60, as described above, with respect to laser output and laser beam wavelength. More specifically, the wavelength of the laser beam LL, output, and oscillation mode of the laser exposure unit 60 are set appropriate to the photosensitive material to be exposed, but in the case of the laser processing unit, the wavelength of the laser beam LL, output, and oscillation mode are appropriate for processing (removal such as cutting or hole punching) of the printed wiring board material MAT (for example, the interlayer insulating resin layer 11c and the second conductor layer 11d) serving as a processing subject layered on the printed wiring board 10.

As a laser beam source suitable for the laser processing unit, it is desirable from the viewpoint of processability (processing performance, cleanliness, or the like) to use a carbon dioxide gas laser or a YAG laser, which can have a large output.

By employing a laser processing unit having the above specifications, in the same manner as exposure, it is possible to perform hole processing on the printed wiring board 10 that forms the via hole 11e constituting a through hole that connects the first conductor layer pattern 11bp and the second conductor layer 11d.

The hole processing can be performed by applying a conventionally known laser via processing method of a printed wiring board, such as a conformal mask method in which copper foil of a hole processing position is removed by etching in advance, a large-window method, a direct-laser method in which a hole is formed in each sheet of copper foil, or the like.

In the present example, the direct-laser method is used, and by one instance of laser processing, the via hole 11e was formed passing through the second conductor layer 11d and the interlayer insulating resin layer 11c and reaching the first conductor layer pattern 11bp.

FIG. 12 is a cross-sectional diagram that shows the cross-sectional state of an example printed wiring board in which a panel plating layer is formed in the via hole shown in FIG. 11.

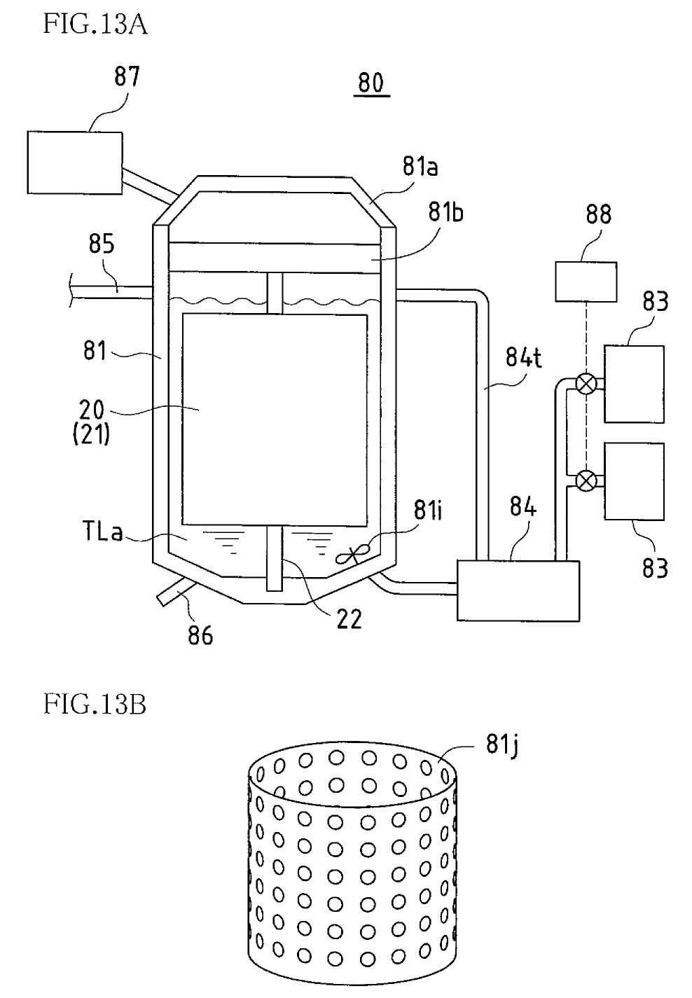

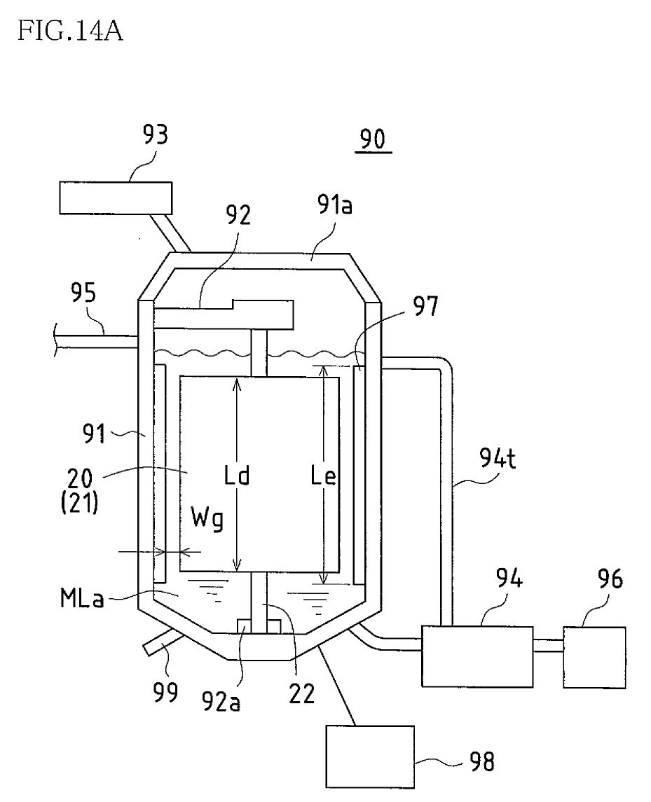

A panel plating layer 11f is formed in order to form a via hole conductor by panel plating the entire face of the printed wiring board 10 where the via hole 11e is formed. A processing unit that forms the panel plating layer 11f will be described with reference to FIGS. 13 to 15. In this example, as with an ordinary printed wiring board, plating treatment is performed in the order of plating pretreatment, electroless plating, electrolytic plating (electrolytic panel plating) in order to form a via hole conductor with electrolytic plating. Also, after plating, the surface of the panel plating layer 11f is polished to place the printed wiring board 10 in the state shown in FIG. 12. In the present example, plating was performed according to a widely known filled via method, and the via hole 11e formed by laser processing was plated in a state filled with plating metal.

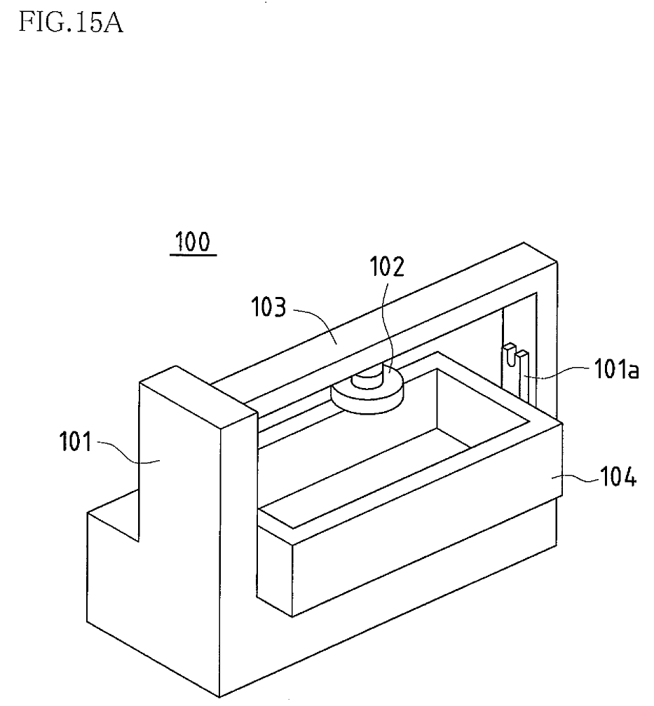

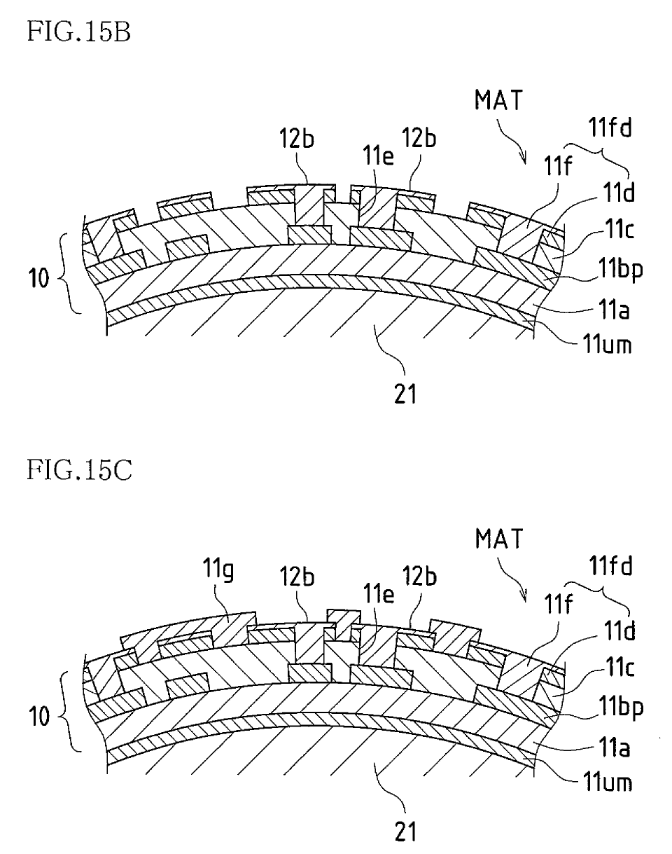

In the present example, the printed wiring board 10 has two conductor layers (the first conductor layer 11b and the second conductor layer 11d). The first conductor layer 11b is an inner layer wiring pattern (the first conductor layer pattern 11bp), and the second conductor layer 11d and the panel plating layer 11f are outer layer wiring patterns (the second conductor layer pattern 11fd; see FIG. 15B). Accordingly, a pattern that includes the component mounting land portion 12b where a component is mounted is formed as the second conductor layer pattern 11fd.

FIG. 13A is a transparent side view that conceptually shows, in a transparent state, the general configuration of a plating pretreatment/electroless plating unit that is one example of a processing unit serving as a constituent element of the printed wiring board manufacturing apparatus according to Embodiment 2 of the present invention. FIG. 13B is a perspective view that conceptually shows another example of an agitating swinging mechanism applied in the plating pretreatment/electroless plating unit shown in FIG. 13A.

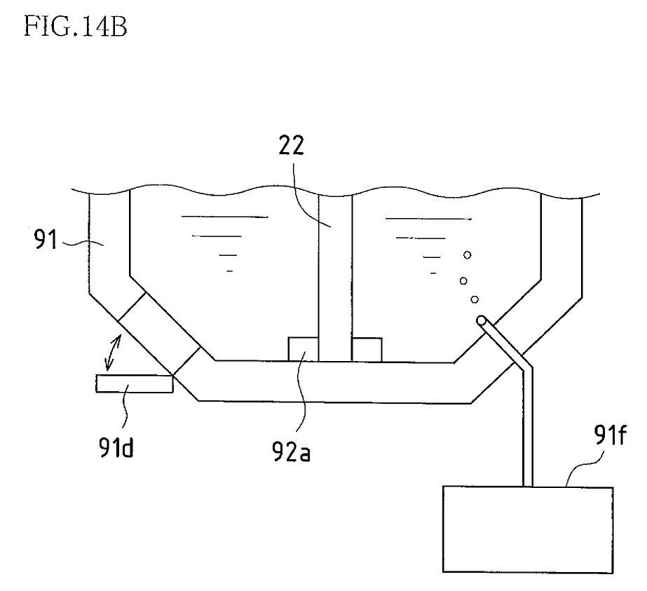

As the plating treatment that forms the panel plating layer 11f, it is necessary to perform plating pretreatment and plating treatment (electrolytic plating or electroless plating). However, it is possible to perform the plating pretreatment with a plating pretreatment unit 80 (also referred to as a processing unit 80) as a processing unit, and to perform the electrolytic plating treatment with an electrolytic plating unit 90 (also referred to a processing unit 90; see FIG. 14A) as a processing unit, and to perform the electroless plating treatment with an electroless plating unit 80 (also referred to as a processing unit 80; the electroless plating unit 80 can have the same configuration as the plating pretreatment unit 80 and so they have the same reference numeral) as a processing unit.

Because the plating pretreatment unit 80 and the electroless plating unit 80 can have the same configuration as stated above, a processing unit 80 (a plating pretreatment/electroless plating unit 80) that performs both plating pretreatment and electroless plating treatment may be adopted. In this example, a processing unit 80 (a plating pretreatment/electroless plating unit 80) that performs both plating pretreatment and electroless plating treatment is adopted as described below.

First, the drum unit 20 is moved to the plating pretreatment/electroless plating unit 80 and plating pretreatment is performed. The plating pretreatment/electroless plating unit 80 is provided with a treatment tank 81 that houses the drum unit 20 (the processing cylinder 21), and a treatment fluid circulation apparatus 84 that circulates treatment fluid (plating pretreatment fluid) TLa injected into the treatment tank 81 around the circumference of the drum unit 20. With this configuration, it is possible to effectively and precisely perform plating pretreatment or electroless plating treatment on printed wiring board material MAT layered on the surface of the processing cylinder 21.

The treatment tank 81a cylindrical vertical-type tank in which the drum unit 20 (the rotational shaft 22) is disposed in the vertical direction, and is configured such that the drum unit 20 (the rotational shaft 22) can be axially supported in the vertical direction by a holding mechanism 81b. Also, by providing a mechanism that rotates the drum unit 20 in the holding mechanism 81b, it is possible to promote and homogenize a reaction.

After disposing the drum unit 20 in the treatment tank 81, a series of treatments prior to electrolytic treatment are performed as plating pretreatment. That is, burr removal etching that removes burrs produced by laser processing (hole processing) of the conductor (the second conductor layer 11d) in order to form the via hole 11e, desmearing, surface treatment, and seeding for electroless plating are performed.

A structure is adopted such that a treatment fluid pipe 84t that supplies the treatment fluid TLa employed in the plating pretreatment is linked to the treatment tank 81, and the treatment fluid TLa is injected from the treatment fluid tank 83 provided outside of the treatment tank 81 into the treatment tank 81 by the treatment fluid circulation apparatus 84, and circulated. A control mechanism (not shown) that manages the temperature and concentration of the treatment fluid TLa is also disposed associated with the treatment fluid circulation apparatus 84. Also, the treatment fluid TLa is exchangeable, or a fluid discharge pipe 86 is provided in order to enable washing.

A washing fluid pipe 85 that supplies washing fluid (for example, such as purified water) that washes the drum unit 20 and the printed wiring board material MAT before and after plating pretreatment or as necessary is linked to the treatment tank 81, and thus appropriate washing processing can be performed by washing (flushing) the drum unit 20 (the printed wiring board material MAT layered on the surface of the drum unit 20).

Also, agitation may be performed using an agitating swinging mechanism (for example, a bladed wheel 81i (FIG. 13A) provided below the treatment tank 81) for removing air bubbles, equalizing the treatment fluid concentration, and equalizing the rate of treatment advancement. Also, the agitating swinging mechanism can be appropriately configured, for example, such that a perforated cylinder 81j (FIG. 13B) is disposed on the same shaft as the drum unit 20, and the perforated cylinder 81j is rotated in the gap between the drum unit 20 and the treatment tank 81. Also, a configuration may be adopted in which an ultrasonic vibrator inside the drum unit 20 is operated, or an ultrasonic oscillator installed inside the treatment tank 81 is operated, thus promoting a reaction in the plating pretreatment, and removing air bubbles that attach to the surface of the printed wiring board 10.

In order to prevent steam and spray of the treatment fluid TLa from exiting outside of the treatment tank 81 and polluting the work environment during the plating pretreatment, the treatment tank 81 is provided with a lid 81a, and further provided with an exhaust treatment portion 87 that appropriately performs detoxification treatment by performing suction and recovery of steam and other exhaust from above the lid 81a.

The basic structure of the treatment tank 81 may be lateral if the structure is such that the drum unit 20 can be fully immersed in the treatment fluid TLa, but it is desirable that the structure is vertical in consideration of the space occupied by the apparatus, circulation of the treatment fluid TLa, swinging, and ease of treating steam or the like.

A configuration is preferably adopted in which the plating pretreatment/electroless plating unit 80 is provided with a plurality of treatment fluid tanks 83 (the plurality of treatment fluid tanks 83 may be appropriately disposed in a line) that each accumulate different treatment fluids, and a treatment fluid switching mechanism 88 that, after the treatment fluid TLa injected into the treatment tank 81 is discharged from the fluid discharge pipe 86, supplies washing fluid from the washing fluid pipe 85 and performs appropriate washing, then switches the linking of the treatment fluid tank 83 and newly injects a different treatment fluid. The treatment fluid switching mechanism 88 can be provided between the plurality of treatment fluid tanks 83 and the treatment fluid circulation apparatus 84, and it is also possible to configure a plurality of separate paths corresponding to the respective treatment fluids.

With this configuration, it is possible to consecutively perform different processing by switching the treatment fluid TLa, so effective plating pretreatment can be performed. Also, an electroless plating unit 80 can be configured by switching the treatment fluid and changing to electroless plating fluid.

Burr removal etching serving as plating pretreatment is performed with the following process. First, by injecting the plating pretreatment fluid TLa into the treatment tank 81, the plating pretreatment/electroless plating unit 80 is configured as a plating pretreatment unit 80.

That is, etching fluid serving as the plating pretreatment fluid TLa is injected into the treatment tank 81 from the corresponding treatment fluid tank 83 and circulated, and burrs of the conductor (the second conductor layer 11d) produced by laser processing are removed by etching. By rotating the drum unit 20 during etching processing, it is possible to perform treatment with good uniformity. After burr removal etching is finished, the etching fluid is removed from the fluid discharge pipe 86, washing fluid (for example, purified water) is injected from the washing fluid pipe 85, and washing is performed.

After washing, in the same manner, desmearing fluid serving as the plating pretreatment fluid TLa is injected, and excess resin residue remaining in the via hole is removed. Next, in the same manner, with a surface treatment agent serving as the plating pretreatment fluid TLa, removal of a surface oxidized film of the conductor layer and adjustment of surface roughness are performed, and with a seeding fluid serving as the plating pretreatment fluid TLa, necessary pretreatment, such as electroless plating seeding, is sequentially performed.

Next, by injecting the electroless plating fluid TLa into the treatment tank 81, the plating pretreatment/electroless plating unit 80 is configured as an electroless plating unit 80, and electroless plating is performed on the printed wiring board 10 (the printed wiring board material MAT). After performing electroless plating at a thickness of several tens of μm on the entire surface, the electroless plating fluid TLa is removed and washing is performed.

FIG. 14A is a transparent side view that conceptually shows, in a transparent state, the general configuration of an electrolytic plating unit that is one example of a processing unit serving as a constituent element of the printed wiring board manufacturing apparatus according to Embodiment 2 of the present invention. FIG. 14B is a transparent side view that conceptually shows, in a transparent state, an example of an anode mud recovery treatment mechanism and an aeration mechanism that are applied in the electrolytic plating unit shown in FIG. 14A.

Next, the drum unit 20 is moved to an electrolytic plating unit 90, and after a plating electric current is applied in an electrolytic plating fluid MLa and electrolytic plating is performed, flushing and drying are performed. As for the plating, basically, with a technique referred to as a filled via method, a state is established in which a hole interior is filled with metal.

The electrolytic plating unit 90 is provided with a plating tank 91 that houses the drum unit 20, a plating fluid circulation apparatus 94 that circulates the electrolytic plating fluid MLa injected into the plating tank 91 around the circumference of the drum unit 20, and an anode electrode 97 that serves as a plating electric current supply portion that supplies a necessary plating electric current in the electrolytic plating treatment. With this configuration, it is possible to effectively and precisely perform electrolytic plating treatment on printed wiring board material MAT layered on the surface of the processing cylinder 21.

Also, because the plated material (the printed wiring board material MAT layered on the surface of the processing cylinder 21) is affixed to the entire surface of the processing cylinder 21, the phenomenon does not occur in which the plate material falls to the plating tank 91, which is a problem in the conventional technology.

The plating tank 91 is a cylindrical vertical-type plating tank in which the drum unit 20 (the rotational shaft 22) is disposed in the vertical direction, and has a configuration in which the drum unit 20 is stably engaged and rotated in the vertical direction by a rotational drive portion 92 that axially supports the rotational shaft 22, and a bearing portion 92a. By rotating the drum unit 20, it is possible to promote and homogenize a reaction in the plating treatment.

The plating tank 91 is a cylindrical vertical-type tank, so it is possible to fully immerse the drum unit 20 in the electrolytic plating fluid MLa, and so it is possible to accommodate the drum unit 20 with good housing and symmetry. Also, by disposing the rotational shaft 22 corresponding to the center of a cylindrical vertical-type tank, it is possible to improve the volume usage ratio, and so it is possible to perform electrolytic plating treatment with a small supply of the electrolytic plating fluid MLa.

That is, in principle, because any configuration may be adopted in which the electrolytic plating fluid MLa is injected into a gap portion (a gap Wg) between the surface of the processing cylinder 21 and an inner wall of the plating tank 91, in comparison to a conventional plating tank, it is possible to perform processing with a very small quantity of electrolytic plating fluid, and so it is possible perform electrolytic plating with a reduced burden on the environment.

A structure is adopted such that a plating fluid pipe 94t that supplies the electrolytic plating fluid MLa employed in the electrolytic plating treatment is linked to the plating tank 91, and the plating fluid MLa is injected from a plating fluid tank 96 provided outside of the plating tank 91 into the plating tank 91 by a plating fluid circulation apparatus 94, and circulated. A control mechanism (not shown) that, for example, manages the temperature and concentration of the plating fluid MLa is also disposed associated with the plating fluid circulation apparatus 94. Also, the treatment fluid MLa is exchangeable, or a fluid discharge pipe 99 is provided in order to enable washing.

A washing fluid pipe 95 that supplies washing fluid (for example, such as purified water) that washes the drum unit 20 and the printed wiring board material MAT before and after electrolytic plating treatment or as necessary is linked to the plating tank 91, and thus appropriate washing processing can be performed by washing (flushing) the drum unit 20 (the printed wiring board material MAT layered on the surface of the drum unit 20).

Also, an agitating swinging mechanism like, for example, the bladed wheel 81i and the perforated cylinder 81j applied in the processing unit 80 may be provided in order to remove air bubbles and equalize the treatment fluid concentration. Also, a configuration may be adopted in which an ultrasonic vibrator inside the drum unit 20 is operated, or an ultrasonic oscillator installed inside the plating tank 91 is operated, thus promoting a reaction in the electrolytic plating treatment, and removing air bubbles that attach to the surface of the printed wiring board 10.

Unlike a conventional plating tank, it is not necessary to take plated material in and out of the plating tank 91 during the plating work, so a lid 91a can easily be provided above the plating tank 91. Also, the plating tank 91 is provided with an exhaust treatment portion 93 linked to the lid 91a that appropriately performs detoxification treatment by performing suction and recovery of steam and other exhaust emitted from the electrolytic plating fluid MLa. That is, by closing the lid 91a during electrolytic plating treatment and recovering exhaust from the electrolytic plating fluid MLa, and safely performing the electrolytic plating treatment, it is possible to suppress a risk of contaminating or corroding the inside of a work room.

The anode electrode 97, for example, is cylindrical or has a plate-like form curved along an inner wall of the plating tank 91, and is disposed along the inner wall of the plating tank 91, so it is possible to apply a uniform high electric field to the drum unit 20 (the processing cylinder 21 and the printed wiring board material MAT subjected to electrolytic plating treatment), and so it is possible to perform electrolytic plating with high precision.

By adopting a cylindrical shape for the anode electrode 97, the gap Wg between the anode electrode 97 and the processing cylinder 21 can be made uniform. By making the gap Wg uniform, it is possible for a uniform electric field to be applied to the printed wiring board material MAT subjected to electrolytic plating treatment, and thus uniform electrolytic plating can be performed.

Also, by having a uniform gap Wg, it is possible to reduce the gap Wg between the anode electrode 97 and the plated material, so the flow speed of the electrolytic plating fluid MLa is inevitably increased, so the growth potential and uniformity of the plating layer are good, and it is possible to realize energy saving, resource saving, and an improvement in reliability. Accordingly, by reducing the gap Wg, and setting the surface of the anode electrode 97 to a sufficiently large size relative to the plated face, it is possible to grow a plating layer with comparatively good uniformity even when plating locations on the surface of the plated material are non-uniformly distributed.

The uniform gap Wg is desirably set in a range from 5 mm to 30 cm. With this configuration, it is possible to precisely and effectively perform electrolytic plating.

When the gap is set to less than 5 mm, due to decentering when rotating the drum unit 20, there is a risk that the drum unit 20 will make contact with the anode electrode 97, and when the gap is set larger than 30 cm, the gap between the drum unit 20 and the plating tank 91 (the anode electrode 97) is large, and so it is difficult to efficiently perform electrolytic plating treatment, and a large amount of the electrolytic plating fluid injected into the plating tank 91 becomes necessary so there is a decrease in productivity.

The anode electrode 97 is disposed at a position facing the processing cylinder 21, and a length Le of the anode electrode 97 in the vertical direction is desirably not less than a length Ld of the processing cylinder 21. With this configuration, it is possible to have a uniform electric field (plating electric current density) for the processing cylinder 21, and thus it is possible to precisely and efficiently perform electrolytic plating treatment.

Also, the length of the anode electrode 97 in the circumferential direction may be a length of an entire circumference (cylindrical), or may be a length with the entire circumference divided into a plurality of portions (curved plate), or may be a length disposed at only a portion in the circumferential direction (curved plate). This is because when performing electrolytic plating treatment, the drum unit 20 is rotated, so the area around the plating is not likely to be affected by the electrode disposition. When the anode electrode 97 spans the entire circumference, it is desirable to symmetrically dispose the anode electrode terminal 97 using the rotational shaft 22 of the drum unit 20 as the axis of symmetry.

Appropriate wiring (not shown) is connected from a plating power source apparatus 98 serving as a plating electric current source such that an appropriate plating electric current can be applied between the anode electrode 97 and the drum unit 20 (the processing cylinder 21).

Because copper is used for the second conductor layer 11d, copper plate for copper plating is used as the material of the anode electrode 97. The material used for the anode electrode 97 is not limited to copper plate; it is also possible to use an insoluble electrode member having the same shape.

In the electrolytic plating unit 90, such that the electrolytic plating fluid MLa normally circulates, and new electrolytic plating fluid MLa always makes contact without unnecessary air bubbles affixing to the surface of the printed wiring board material MAT formed on the processing cylinder 21, it is desirable to improve plating precision by providing, for example, a fibrillation mechanism that finely vibrates and shakes the drum unit 20, or an agitation mechanism that agitates the electrolytic plating fluid MLa. That is, a plating precision adjustment mechanism is desirably provided that improves plating precision by adjusting the circulation state of the electrolytic plating fluid MLa, or the surface state of the printed wiring board material MAT, such as, for example, an agitation blade or an ultrasonic apparatus.

The electrolytic plating unit 90 desirably has an anode mud recovery treatment mechanism 91d (FIG. 14B), namely a door or drain such that a portion of a treatment tank bottom portion can open in order to perform treatment to recover anode mud that deposits on the bottom portion of the plating tank 91, or an aeration mechanism 91f (FIG. 14B) that supplies air or oxygen inside of the plating tank 91 in order to perform agitation oxidation dissolution treatment on the anode mud, provided in the plating tank 91. With this configuration, it is possible to effectively process anode mud so that electrolytic plating efficiency can be improved, and thus it is possible to improve the usage efficiency of the plating tank 91.

As described above, the processing unit 80 (the plating pretreatment/electroless plating unit 80; FIG. 13A) used for both plating pretreatment and electroless plating treatment, and the electrolytic plating unit 90 (the processing unit 90; see FIG. 14A) that performs electrolytic plating treatment were provided, but these can be integrated in a single body, and provided as a plating pretreatment/electroless plating/electrolytic plating unit.

FIG. 15A is a perspective view that conceptually shows the general configuration of a polishing unit that is one example of a processing unit serving as a constituent element of the printed wiring board manufacturing apparatus according to Embodiment 2 of the present invention. FIG. 15B is a cross-sectional diagram that shows the cross-sectional state of a printed wiring board in which a second conductor layer pattern is formed by patterning the panel plating layer shown in FIG. 12 and a second conductor layer. FIG. 15C is a cross-sectional view that shows the cross-sectional state of a printed wiring board in which a solder resist is formed on the second conductor layer pattern formed in FIG. 15B.

After plating treatment is completed, the drum unit 20 is placed in a polishing unit 100 (also referred to as a processing unit 100) that serves as a processing unit. The polishing unit 100 is provided with a rotational drive portion 101 that rotationally drives the drum unit 20 (not shown) with the rotational shaft 22 axially supported with a shaft bearing portion 101a, a polishing portion 102 that polishes the printed wiring board material MAT layered on the surface of the processing cylinder 21, and a polishing moving portion 103 that moves the polishing portion 102 parallel to the rotational shaft 22.

The polishing portion 102 is configured with a polishing stone that rotates, a polishing plate, or a buff. Printed wiring board material MAT is polished by rotating the drum unit 20 in a state with the polishing portion 102 pressed against the surface (the printed wiring board material MAT) of the processing cylinder with a predetermined pressure, and by moving the polishing portion 102 with the polishing moving portion 103, the entire surface of the printed wiring board material MAT is polished.

It is also possible to provide a shower mechanism such that when polishing with the polishing portion 102, polishing and washing are performed while showering with polishing fluid (polishing agent) and washing fluid. Also, it is possible to perform surface treatment by showering a soft etching agent or the like after polishing. In such a case, an accumulation tank 104 is provided that corresponds to the drum unit 20, and recovers and accumulates polishing agent and washing fluid.

Also, in the case of surface treatment involving washing or the like in which it is not necessary to polish the printed wiring board material MAT, respective treatments may be separately performed, using an acid wash unit, a soft etching unit, a flushing unit, or the like structured similar to the development unit 70. By adopting a configuration provided with a rotational drive portion corresponding to the rotational drive portion 71, a shower mechanism corresponding to the shower mechanism 72, an accumulation tank corresponding to the accumulation tank 73, and a control portion corresponding to the control portion 74, each by way of example, the treatment of each of an acid wash unit, soft etching unit, and flushing unit can be performed easily and precisely.

With the polishing unit 100, stretching of printed wiring board material MAT that occurs with a conventional polishing unit that polishes by pressing a rotating brush against sheet-like printed wiring board material is very small, and it is possible to maintain and improve the dimensional precision of the printed wiring board 10.

After polishing the panel plating layer 11f, the panel plating layer 11f and the second conductor layer 11d are patterned to form a second conductor layer pattern 11fd (FIG. 15B) with the same method as the method used to form the first conductor layer pattern 11bp.

Further, a photosensitive solder resist layer is layered and patterned to form a solder resist layer pattern 11g (FIG. 11C) with the same method as the method used to form the above-described dry film (the etching resist dry film 11bc). Afterward, the printed wiring board 10 is completed on the drum unit 20 by performing, as necessary, surface treatment of a terminal portion (the component mounting land portion 12b) of the printed wiring board 10 such as plating treatment or rust-proofing processing, performed by a surface treatment unit with a structure similar to the development unit 70, the electrolytic plating unit 90, or the like.

FIG. 16A is a perspective view that conceptually shows the general configuration of one example of a processing unit serving as a constituent element of the printed wiring board manufacturing apparatus according to Embodiment 2 of the present invention. FIG. 16B is a block diagram that shows the block configuration of a printing unit shown in FIG. 16A.

After establishing the state shown in FIG. 15C, further, silk printing processing is performed by a printing unit 110 (also referred to as a processing unit 110) that serves as a processing unit. That is, the printing unit 110 is, corresponding to the drum unit 20, linked to the rotational drive unit in which the drum unit 20 is installed.

The printing unit 110 is provided with an ink ejection head 111 that, in a state in which the drum unit 20 has been installed in the rotational drive unit 30, in synchronization with rotation of the processing cylinder 21, ejects a printing ink INK (silk printing ink) to printed wiring board material MAT that has been layered on the surface of the processing cylinder 21, and a head movement portion 112 that moves the ink ejection head 111 parallel to the rotational shaft 22, and a printing drive control portion 113 that drives and controls the ink ejection head 111 and the head movement portion 112 (FIG. 16A). With this configuration, it is possible to perform printing employing the printing ink INK, and thus printing can be performed efficiently and with high precision.

The printing unit 110 (ink ejection head 111) is provided with, for example, an ink tank 111a that supplied the printing ink INK, and an ink ejection mechanism 111b that serves as a tip portion that ejects ink (FIG. 16B). A configuration is also possible in which the ink tank 111a is disposed outside of the ink ejection head 111

The printing unit 110 (printing drive control portion 113) is connected via the interface portion 35 and an interface portion 116 to the rotation detection mechanism 36, which is configured with a linear encoder that detects a processing position, and is also connected to a CAD/CAM system via a CAD data writing/conversion portion 115. The CAD data writing/conversion portion 115 converts CAD data received from the CAD/CAM system to processing data and inputs the converted data to the printing drive control portion 113 (FIG. 16B).

The printing drive control portion 113 controls the ink ejection mechanism 111b and the head movement portion 112. Accordingly, the printing drive control portion 113 is capable of confirming the rotational position of the processing cylinder 21, which rotates according to the rotational drive unit 30, based on signals from the rotational drive unit 30, and is capable of moving the ink ejection head 111 in the axial direction of the rotational shaft 22.

The printing unit 110 can be configured with basically the same structure as an inkjet printer. While rotating the drum unit 20 (processing cylinder 21), the ink ejection head 111 is moved parallel to the rotational shaft, print data read by the printing drive control portion 113 is converted to ink ejection data, the printing ink INK is ejected from the print head 111 (ink ejection mechanism 111b), and thus necessary characters are printed on the printed wiring board 10 (the printed wiring board material MAT).

Also, in the same manner as the etching resist film 11bc was formed, it is possible to apply photosensitive resin with the film layering unit 40, perform exposure with the laser exposure unit 60, and develop with the development unit 70 to form silk characters.

The printing unit 110 is provided with an ink drying apparatus (not shown) that dries (dry to touch, dry-hardening) printing ink ejected to the printed wiring board material MAT. The ink drying apparatus, for example, can be configured with an infrared lamp that heats the surface of the processing cylinder 21, an air blower that blows air to the surface of the processing cylinder 21, or the like. With this configuration it is possible to efficiently dry printing ink in a clean state.

The printing unit 110 is linked to the rotational drive unit 30, so it is possible to move the ink drying apparatus in coordination with the temperature adjustment mechanism including the drum unit 20. That is, it is possible to apply heat to the processing cylinder 21 (the printed wiring board 10) with the temperature adjustment mechanism in synchronization with operation of the ink drying apparatus. With this configuration, it is possible to more efficiently and swiftly dry the printing ink.

FIGS. 17A to 17D illustrate a state in which after processing with the drum unit 20, the printed wiring board is removed, and processing in a predetermined shape.

FIG. 17A is a side view that conceptually shows a state immediately after a printed wiring board manufactured by the printed wiring board manufacturing apparatus according to Embodiment 2 of the present invention has been formed in a processing cylinder. FIG. 17B is a perspective view that schematically shows a state in which the printed wiring board shown in FIG. 17A is cut by a laser. FIG. 17C is a side view that conceptually shows a state in which the printed wiring board shown in FIG. 17A has been separated from the processing cylinder. FIG. 17D is a perspective view that conceptually shows a state in which the printed wiring board shown in FIG. 17C has been removed from the processing cylinder and completed.

Immediately after finishing processing with the processing cylinder 21, the printed wiring board 10a (10) is in a state with the printed wiring board affixed to the surface of the processing cylinder in a cylindrical shape (FIG. 17A). In order to form two of the arc-like printed wiring boards 10b (10) by, for example, dividing the cylindrical printed wiring board 10a into two sections in the circumferential direction, a laser beam LL of the laser processing unit is irradiated corresponding to a cutting line CL in the axial direction of the processing cylinder 21, thus cutting the printed wiring board 10 (FIG. 17B). When dividing in the axial direction, a configuration may be adopted in which the laser beam LL is irradiated intersecting in the axial direction.

A configuration is also possible in which the printed wiring board 10a is removed from the processing cylinder 21 and then divided to produce the printed wiring board 10b. Also note that when the cylindrical printed wiring board 10a is used as the final shape, it is not necessary to perform cutting in the axial direction of the processing cylinder 21.

Next, the plate linking portions 25a, 25b, 25c, and 25d are driven via a cam/link mechanism or the like by operating the radial control lever 23 of the drum unit 20 to pull the processing cylinder 21 (processing jig plates 21a, 21b, 21c, and 21d), divided for example into four sections, toward the rotational shaft 22, and thus the outer circumference of the processing cylinder 21 is reduced (FIG. 17C).

As a result, the processing jig plates 21a, 21b, 21c, and 21d are separated from the printed wiring board 10, so it is possible to separate the printed wiring board 10 from the drum unit 20. That is, this is a removal step of removing the printed wiring board 10 that has been formed from the processing cylinder 21 by repeating the material layering step and the processing step.

Afterward, the metal underlayer hum on the back face (inner circumferential face that was in contact with the processing cylinder 21) of the printed wiring board is removed by etching, obtaining the printed wiring board 10b as a completed good (FIG. 17D). Also, a configuration can be adopted in which without cutting at the cutting line CL, the printed wiring board 10 is peeled away from the processing cylinder 21 in the axial direction of the rotational shaft 22 while in a cylindrical shape, machining and post-processing are performed, and thus a cylindrical printed wiring board 10 is obtained as a completed good.

In the present embodiment, a printed wiring board 10 having two conductor layers (the first conductor layer 11b and the second conductor layer 11d) is used, but it is also possible to form a multilayer printed wiring board 10 configured by repeatedly performing the same step and overlaying a desired number of layers.

With the present invention, it is possible to easily and precisely manufacture a cylindrical multilayer printed wiring board 10 that was impossible in reality with the conventional technology, and it is possible to adopt a substrate shape that is easily implemented in an electronic device. Accordingly, it is possible to improve wiring freedom and wiring density, and a printed wiring board 10 is realized that, particularly when implementation in a cylindrical space is necessary, has a very high efficiency of disposition.

In the present embodiment, processing is performed in a state with the printed wiring board material MAT affixed to the cylindrical drum unit 20 (processing cylinder 21), and because an open end is not present in the circumferential direction, and the processing cylinder 21 has sufficient rigidity; as also stated with respect to the polishing processing by the processing unit 100, there is a very small change in size of the printed wiring board material MAT in the processing step that was a problem with the conventional processing method, so positioning can be precisely and easily performed in each processing step, and thus it is possible to easily manufacture a precise printed wiring board 10 in which dimensional change is suppressed.

That is, with the conventional processing method, because the printed wiring board material has an open end on four sides, deformation due to absorption of treatment fluid and washing fluid, deformation due to drying, and deformation due to mechanical force such as polishing occur in each processing step, and deformation due to alleviation of internal stress when etching or plating and due to layering also occur, so there is the problem that changes in the size of the printed wiring board are likely to occur, but in the present embodiment, it is possible reliably suppress such a problem.

As described above, in the present embodiment, roll-like/sheet-like printed wiring board material MAT is layered (affixed) on the surface of the cylindrical outer circumference of the processing cylinder 21, and fluid-like printed wiring board material MAT is applied, or these steps are repeated, so that it is possible to perform processing of printed wiring board material (mechanical processing such as hole processing, plating treatment such as panel plating, or other processing necessary for manufacturing a printed wiring board 10), and thus it is possible to very easily and smoothly manufacture a printed wiring board having a curved shape that corresponds to the surface shape of the processing cylinder 21.

Also, because all of the processing such as wire formation, hole processing, and the like is performed on cylindrical (in a curved state) printed wiring board material MAT, problems that occurred with a conventional flexible printed wiring board, such as breakage due to folding, layers peeling away from each other, and the like, do not occur with the present embodiment.

Also, with the printed wiring board manufacturing apparatus according to the present embodiment, it is possible to greatly reduce the installation area of the apparatus, resulting in a compact manufacturing apparatus. With a printed wiring board manufacturing apparatus that manufactures a conventional flat printed wiring board, for example, even a single etching or plating apparatus has a width of several meters and a length from several meters to tens of meters, and in all processing steps, an installation area of tens of meters square is necessary. On the other hand, with the printed wiring board manufacturing apparatus according to the present embodiment, the drum unit 20 is compatible with about all of the processing, and distance in the lengthwise direction is not needed, so it is possible to perform all processing in an installation area of at most several meters square.

Also, with the printed wiring board manufacturing method according to the present embodiment, a printed wiring board 10 is manufactured by layering printed wiring board material MAT that forms the printed wiring board 10, and performing processing on the printed wiring board material MAT. The printed wiring board manufacturing method according to the present embodiment is provided with a cylinder preparation step of preparing a processing cylinder 21 on which printed wiring board material MAT will be layered, a material layering step of layering printed wiring board material MAT on the processing cylinder 21, a processing step of performing processing on the printed wiring board material MAT that has been layered on the processing cylinder 21, and a removal step of removing the printed wiring board 10 formed by repeating the material layering step and the processing step from the processing cylinder 21.

With this configuration, the component mounting area is curved, and mounting and arrangement in a small space is possible, so it is possible to precisely and easily form a printed wiring board that is highly adaptable to a case of an electronic device. Also, with respect to the printed wiring board material, the material layering step, the processing step, and the like, conventionally known technology can be appropriately applied in each case, so it is possible to easily and efficiently manufacture a curved printed wiring board 10 according to the present invention. Also, because basically conventionally existing technology (such as printed wiring board material, the material layering step, the processing step, and the like) is applied, it is possible to manufacture a printed wiring board having high reliability.

### Embodiment 3

In Embodiment 2, a case was disclosed in which a component mounting land portion where an electronic component is mounted is disposed on the outer circumference side of a cylindrical printed wiring board 10, but in the present embodiment, the component mounting land portion is disposed on the inner circumferential face (face opposite to that in Embodiment 2).

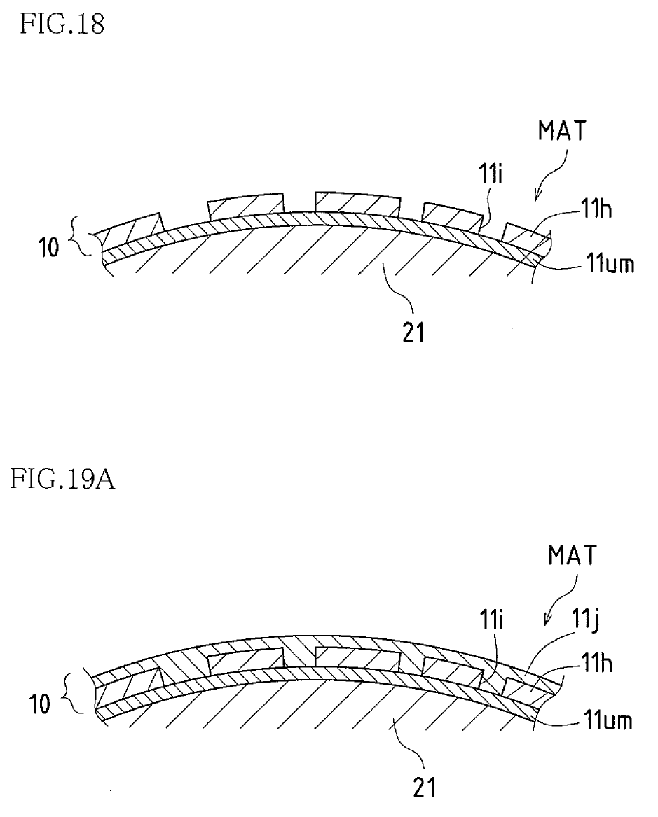

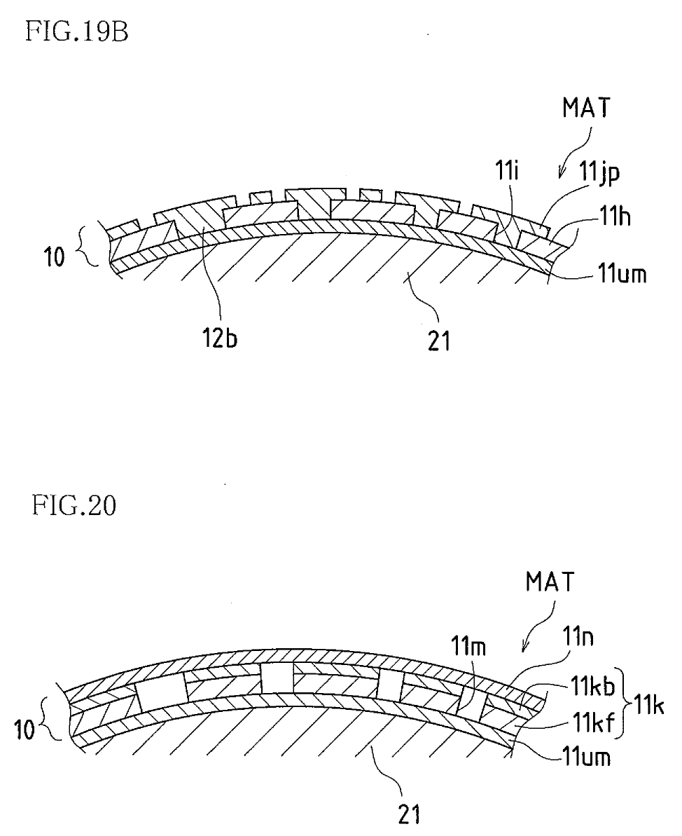

FIGS. 18, 19A and 19B are cross-sectional views that show the cross-sectional state of a printed wiring board formed by a printed wiring board manufacturing apparatus (printed wiring board manufacturing method) according to Embodiment 3 of the present invention.

The processing units and processing procedure applied in the present embodiment are basically the same as in Embodiment 2, and so in the present embodiment, mainly the processing procedure for layering is described using a cross-section of the printed wiring board 10. Other aspects of the configuration are the same as in Embodiments 1 and 2, so they are appropriately cited and mainly the differing points are described here.

First, formation of the thin metal underlayer hum on the surface of the processing cylinder 21 is the same as in the case of Embodiment 2. Next, with the printed wiring board 10 in a completed state, a photosensitive solder resist layer that is a solder resist layer pattern 11h is formed by layering. Laser exposure is performed on the photosensitive solder resist layer using the laser exposure unit 60, and by using the development unit 70 to perform development treatment, a solder resist opening portion 11i is formed, making the solder resist layer pattern 11h (FIG. 18).

Next, whole-face plating is performed to form a plating conductor layer 11j (FIG. 19A). In the present embodiment as well, a filled via method is adopted for the plating conductor layer 11j, so that the solder resist opening portion 11i is filled. When plating, a plating electric current may be applied to the metal underlayer 11um, and the metal underlayer hum used as a plating electrode. Also, it is possible to adopt a configuration in which the plating conductor layer 11j is formed not by plating the entire face of the plating conductor layer 11j, but by layering a metal foil such as copper foil.

After polishing and surface treatment of the surface of the plating conductor layer 11j, appropriate patterning is performed. That is, by patterning the plating conductor layer 11j, a pattern that includes the component mounting land portion 12b exposed to the surface of the concave face side of the printed wiring board 10 is formed as a second conductor pattern 11jp (FIG. 19B).

As for the subsequent procedure, same as in Embodiment 2, by repeatedly performing layering processing and patterning processing of the printed wiring board material MAT, it is possible to form a printed wiring board 10 having a desired layer structure, so a description thereof is omitted here.

### Embodiment 4

In Embodiments 2 and 3, a solder resist layer (11h) was formed as a surface layer, but in the present embodiment, a film coverlay often used in flexible printed wiring boards is used instead of a solder resist layer (11h). Other aspects of the configuration are the same as in Embodiment 1 and others, so they are appropriately cited and mainly the differing points are described here.

FIG. 20 is a cross-sectional view that shows the cross-sectional state of a printed wiring board formed by a printed wiring board manufacturing apparatus (printed wiring board manufacturing method) according to Embodiment 4 of the present invention.

In a commercially available coverlay material (film coverlay), an adhesive is applied to a polyimide or polyester resin film. After processing a necessary opening portion with metal or the like in advance, the film layering unit 40 is used to perform layering on the drum unit 20.

First, same as in Embodiments 2 and 3, a thin metal underlayer hum is formed on the surface of the processing cylinder 21. Next, a film coverlay 11k is formed (formed such that a resin film 11kf is disposed on the metal underlayer hum side, and an adhesive 11kb is disposed on the outer circumference side), with a coverlay opening portion 11m formed in the film coverlay 11k. Further, a conductor foil 11n is layered on the surface of the film coverlay 11k (the adhesive 11kb) using the film layering unit 40. In this state, processing is performed to apply heat and pressure with the vacuum press unit 50, and thus establish a state that is the same as in Embodiment 3 (FIG. 19A). Subsequent steps are the same as in Embodiment 3 so a description thereof is omitted here.

### Embodiment 5

In the present embodiment, the etching method performed in Embodiments 2 and 3 is not used; an additive method is adopted in which all patterns are formed with a plating method. Other aspects of the configuration are the same as in Embodiment 1, so they are appropriately cited and mainly the differing points are described here.

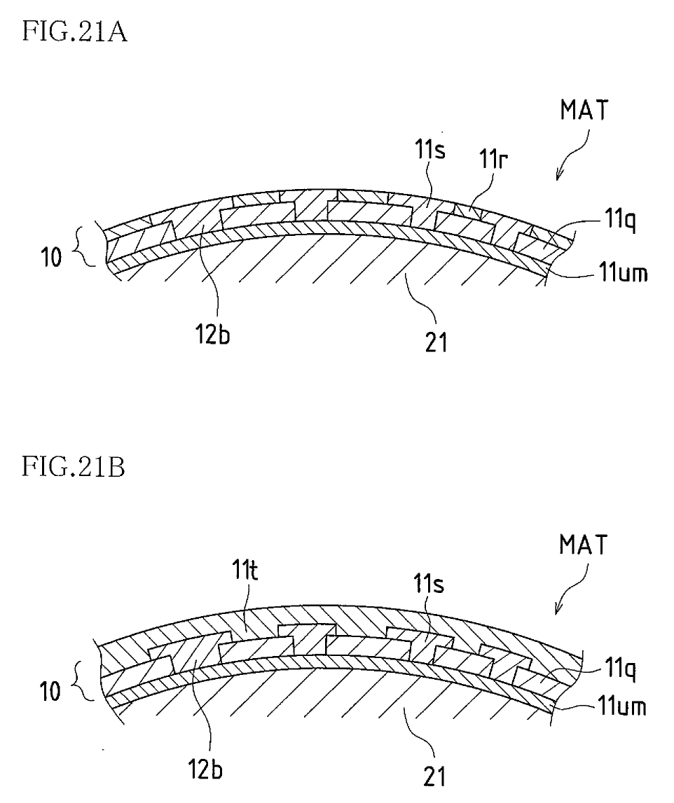

FIGS. 21A and 21B are cross-sectional views that show the cross-sectional state of a printed wiring board formed by a printed wiring board manufacturing apparatus (printed wiring board manufacturing method) according to Embodiment 5 of the present invention.

First, same as in Embodiment 3 (FIG. 18), a solder resist layer 11q is formed in which the component mounting land portion 12b has been formed. Next, a plating resist 11r is formed on the solder resist layer 11q. Formation of the plating resist 11r is performed using the film layering unit 40, the laser exposure unit 60, and the development unit 70.

The plating resist 11r is formed as a reverse pattern of the component mounting land portion 12b or the pattern portion (a plating conductor pattern 11s), so by next performing plating treatment the plating conductor pattern 11s and the component mounting land portion 12b are formed (FIG. 21A). After the plating conductor pattern 11s is formed, the plating resist 11r is removed, a semi-hardened resin sheet used as an interlayer insulating resin layer 11t (FIG. 21B) is formed by layering on the surface of the plating conductor pattern 11s and hardened, and then processing proceeds to via hole processing. Subsequently these steps are (formation of the plating conductor pattern 11s and the interlayer insulating resin layer 11t) are repeated.

In the present embodiment, same as in Embodiment 2 (FIGS. 10 and 11), hole processing can be performed with a laser processing unit after a semi-hardened resin film used as an interlayer insulating layer is layered, and the semi-hardened resin film is completely hardened, or alternatively, is hardened until slightly before complete hardening (for example, to about 70 to 90% of complete hardening) by applying vacuum pressing with the vacuum pressing unit 50 or, using press molds 171a and 171b (see FIG. 27) of a mold press unit 170 having a curved face corresponding to the processing cylinder 21.

Also, it is possible to, instead of the plating resist 11r, directly laminate an interlayer insulating resin layer, and perform laser processing on the interlayer insulating resin layer to form a reverse pattern of the circuit pattern, and form a circuit pattern by plating treatment.

In the present embodiment, the plating conductor pattern 11s formed in the via hole of the solder resist 11q is controlled so as to not protrude from the surface of the plating resist 11r, but a configuration is also possible in which plating is performed until the plating conductor pattern 11s protrudes from the surface of the plating resist 11r, or until spreading to the surface of the plating resist 11r, and afterward, polished or removed by etching to obtain the shape shown in FIG. 21A.

### Embodiment 6

In the present embodiment, a via hole is formed with a further differing method. That is, in Embodiment 2 (FIG. 11), hole processing that forms the via hole 11e was performed by a laser beam using a laser processing unit, but in the present embodiment, another method known as a photo via method is applied. Aspects of the other configuration are same as in Embodiment 1 and others, so they are appropriately cited and mainly the differing points are described here.

In the present embodiment, after the first conductor layer pattern 11bp is formed, photosensitive resin is layered to form an interlayer insulating resin layer. After forming the interlayer insulating resin layer (photosensitive resin), photosensitive resin at a via hole position is melted and removed by development treatment using the laser exposure unit 60, and then a via hole is formed at the via hole position by performing development with the development unit 70. That is, in the present embodiment, a via hole is formed by performing exposure and development using photosensitive resin.

### Embodiment 7

In Embodiments 2 to 6, photosensitive resin formed as a film as an etching resist, a solder resist, or the like was used, but in the present embodiment, a configuration is adopted in which instead of film-like photosensitive resin, a fluid (such as photosensitive fluid resin) is applied to form a resin film of an etching resist, solder resist, or the like. That is, in the case of layering photosensitive resin formed as a film, the film layering unit 40 was used, but in the present embodiment a fluid is applied, so an application unit is used as a processing unit. Also, the form of the application unit includes the two forms shown in FIGS. 22 and 23.

FIG. 22 is a side view that conceptually shows the general configuration of an application unit that is one example of a processing unit serving as a constituent element of the printed wiring board manufacturing apparatus (printed wiring board manufacturing method) according to Embodiment 7 of the present invention.

An application unit 120 (also referred to as a processing unit 120) serving as a processing unit is provided with an application fluid supply portion 121 that supplies an application fluid PLa as printed wiring board material MAT, and an application portion 122 that applies application fluid PLa supplied from the application fluid supply portion 121 to printed wiring board material MAT layered on the surface of the processing cylinder 21. With this configuration, it is possible to supply the application fluid PLa to the processing cylinder, and apply that application fluid PLa at a predetermined thickness to easily and precisely form a resin film (not shown).

Application fluid PLa ejected from the application fluid supply portion 121 configured with a resin tank is spread with matched rollers 123a and 123b disposed facing a discharge port of the application fluid supply portion 121, and transferred to the application portion 122 configured with a transfer roller that makes contact with the matched roller 123b. The application portion 22 in contact with the processing cylinder 21 further transfers the transferred application fluid PLa to the surface of the processing cylinder 21, and forms a resin film. Because the application portion 122 is configured with a transfer roller, it is possible to form a resin film with a comparatively thin predetermined film thickness.

The processing cylinder 21 is configured to rotate in coordination with the transfer roller of the application portion 122. Rotational driving of the processing cylinder 21 can be controlled by linking the drum unit 20 to the rotational drive unit 30, but it is also possible to adopt a configuration having a rotational drive portion in which the application unit 120 rotationally drives the drum unit 20 (for example, a configuration like that of the rotational drive portion 71 can be adopted).

Also, the application unit 120 is provided with a control portion (for example, configured like the control portion 74 or the like) that controls the application fluid supply portion 121, the application portion 122, and the matched rollers 123a and 123b.

FIG. 23 is a side view that conceptually shows the general configuration of a modified example of an application unit that is one example of a processing unit serving as a constituent element of the printed wiring board manufacturing apparatus (printed wiring board manufacturing method) according to Embodiment 7 of the present invention.

An application unit 130 (also referred to as a processing unit 130) serving as a processing unit is provided with an application fluid supply portion 131 that supplies an application fluid PLa as printed wiring board material MAT, and an application portion 132 that applies application fluid PLa supplied from the application fluid supply portion 131 to printed wiring board material MAT layered on the surface of the processing cylinder 21. With this configuration, it is possible to supply the application fluid PLa to the processing cylinder, and apply that application fluid PLa at a predetermined thickness to easily and precisely form a resin film (not shown).

A portion of the processing cylinder 21 is immersed in the application fluid supply portion 131 configured from an application fluid repository tub filled with application fluid PLa, and while rotating the processing cylinder 21, a resin film is formed by the application portion 132 configured with a squeegee. The application portion 132 is configured with a squeegee, so it is possible to form a resin film of a predetermined film thickness by adjusting the squeegee position. At the point in time that the predetermined thickness is reached, it is possible to control the film thickness by lifting the processing cylinder up from the application fluid supply portion.

Rotational driving of the processing cylinder 21 can be controlled by linking the drum unit 20 to the rotational drive unit 30, but it is also possible to adopt a configuration having a rotational drive portion in which the application unit 130 rotationally drives the drum unit 20 (for example, a configuration similar to that shown in FIG. 22 can be adopted).

The application units 120 and 130 are desirably further provided with a film quality change portion (not shown) that changes the application fluid PLa that has been applied to the processing cylinder 21 (surface of the printed wiring board material MAT) to a resin film having a predetermined film quality. As a specific means of changing the film quality, an appropriate heating means or hardening means can be applied, such as a heater or heating/blowing unit.

Also, it is possible to apply a processing unit (film quality change unit) having a film quality change portion separated from the application units 120 and 130.

### Embodiment 8

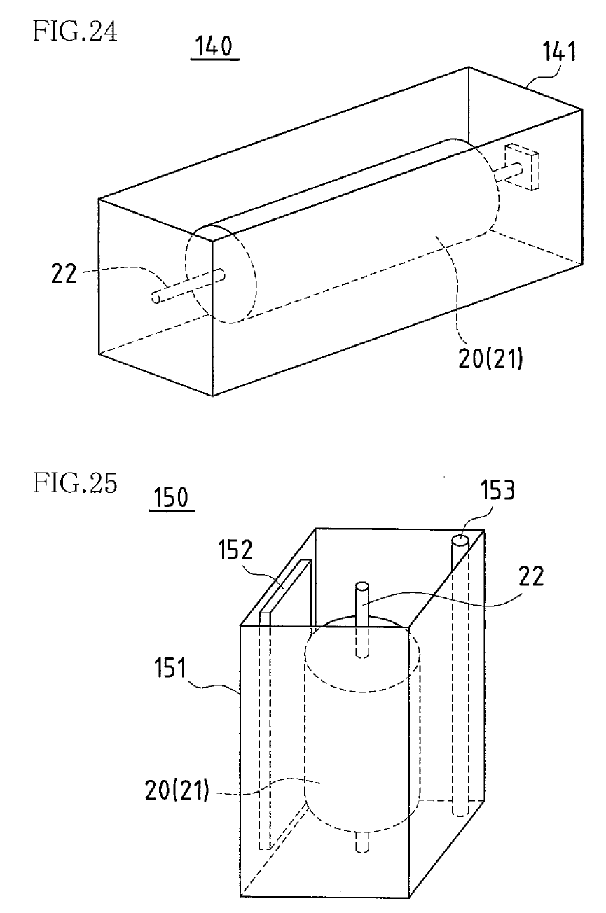

As Embodiment 8, a modified example of the electrolytic plating unit shown in FIG. 14A will be described with reference to FIGS. 24, 25, and 26.

FIG. 24 is a perspective view that conceptually shows the general configuration of a modified example of an electrolytic plating unit that is one example of a processing unit that serves as a constituent element of the printed wiring board manufacturing apparatus (printed wiring board manufacturing method) according to Embodiment 8 of the present invention.

An electrolytic plating unit 140 (also referred to as a processing unit 140) serving as a processing unit differs from the electrolytic plating unit 90 in that the electrolytic plating unit 140 is provided with a horizontal-type plating tank 141 in which the drum unit 20 (the rotational shaft 22) is disposed in the horizontal direction. Other aspects of the configuration can be the same in the configuration of the electrolytic plating unit 90, so mainly the differing points are described here.

With the plating tank 141, the drum unit 20 may be semi-submerged, or as with the plating tank 91, the drum unit 20 may be fully submerged.

Other aspects of the configuration, such as a plating electric current supply portion that supplies electric current necessary for electrolytic plating treatment, and a plating fluid circulation apparatus that circulates electrolytic plating fluid injected into the plating tank 141 around the circumference of the drum unit 20, can be the same as in the configuration of the electrolytic plating unit 90.

FIG. 25 is a perspective view that conceptually shows the general configuration of a modified example of an electrolytic plating unit that is one example of a processing unit that serves as a constituent element of the printed wiring board manufacturing apparatus (printed wiring board manufacturing method) according to Embodiment 8 of the present invention.

An electrolytic plating unit 150 (also referred to as a processing unit 150) serving as a processing unit is provided with a vertical rectangular (pillar-like) plating tank 151 in which the drum unit 20 (the rotational shaft 22) is disposed in the vertical direction. In consideration of symmetry relative to the drum unit 20, it is desirable that the horizontal cross-section of the vertical rectangle is square.

Also, because the plating tank 151 is a vertical rectangular body whose circumferential side faces have a flat shape, as a plating electric current supply portion that supplies electric current necessary for electrolytic plating treatment, either a plate-like anode electrode 152 disposed corresponding to a wall face of the vertical rectangular body, or a bar-like anode electrode 153 disposed in a corner of the vertical rectangular solid, is provided in the plating tank 151. Accordingly, the shape and configuration of the anode electrodes 152 and 153 can be simplified. Also, it is possible to simplify the structure of the pipe shape or the like.

That is, the electrolytic plating unit 150 differs from the electrolytic plating unit 90 in that the plating tank 151 is a vertical rectangular body, and either the plate-like anode electrode 152 corresponding to a wall face of the vertical rectangular body or the bar-like anode electrode 153 is provided in the plating tank 151. Other aspects of the configuration can be the same as in the electrolytic plating unit 90, so mainly the differing points are described here.

The plate-like anode electrode 152 is desirably disposed along at least one face of the plating tank 151. The bar-like anode electrode 153 is desirably disposed in at least one corner of the plating tank 151.

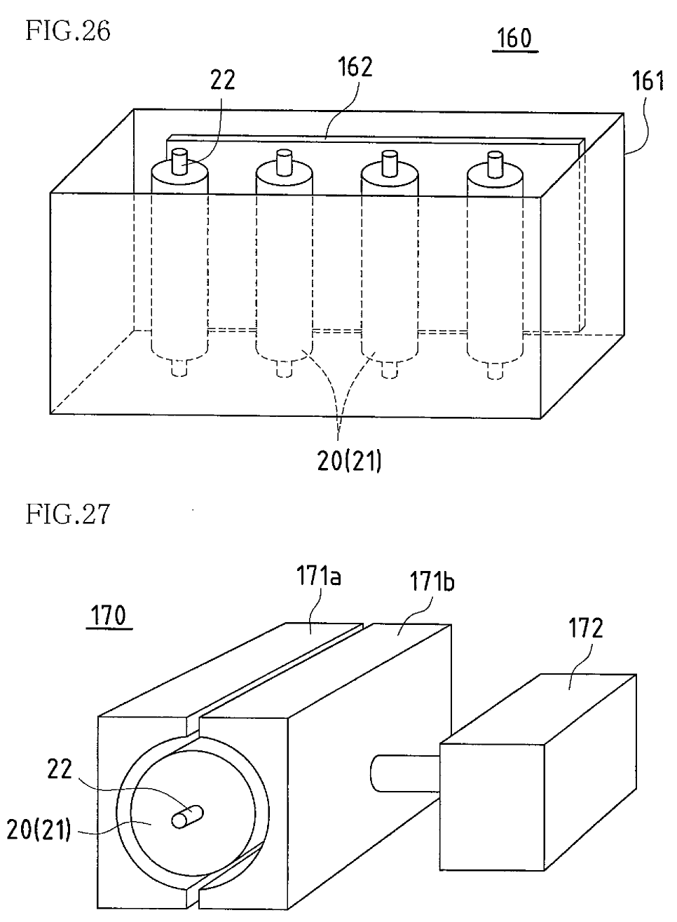

FIG. 26 is a perspective view that conceptually shows the general configuration of a modified example of an electrolytic plating unit that is one example of a processing unit that serves as a constituent element of the printed wiring board manufacturing apparatus (printed wiring board manufacturing method) according to Embodiment 8 of the present invention.

An electrolytic plating unit 160 (also referred to as a processing unit 160) serving as a processing unit differs from the electrolytic plating unit 150 in that the electrolytic plating unit 160 is provided with a horizontal articulating-type plating tank 161 in which a plurality of the drum units 20 disposed in the vertical direction are arranged in a horizontal line. Other aspects of the configuration can be the same as in the configuration of the electrolytic plating tank 150, and so mainly the differing points are described here.

Because a plurality of the drum units 20 are arranged in a horizontal line, the cross-section of the horizontal articulating-type plating tank 161 in the horizontal direction is rectangular, but various modifications are possible, such as a connected form in which a plurality of the plating tanks 91 of the electrolytic plating unit 90 are linked. Because it is possible to perform electrolytic plating treatment simultaneously by arranging a plurality of the drum units 20 in a line, it is possible to perform electrolytic plating treatment with good productivity.

Also, a plate-like anode electrode 162 is provided as a plating electric current supply portion and is disposed corresponding to a horizontal articulating-type wall face. Instead of the plate-like anode electrode 162, between each of the plurality of drum units 20, or at appropriate positions, it is possible to dispose an anode electrode that is plate-like or bar-like, or a lump-like anode electrode that has been inserted into an anode bag.

The electrolytic plating unit 160 may be structured so that electrolytic plating treatment can be performed with a plurality of the drum units 20 arranged in a vertical line, and is not limited to the shapes and arrangements described above.

### Embodiment 9

FIG. 27 is a perspective view that conceptually shows the general configuration of a shaping press unit that is one example of a processing unit that serves as a constituent element of the printed wiring board manufacturing apparatus (printed wiring board manufacturing method) according to Embodiment 9 of the present invention.

A mold press unit 170 (also referred to as a processing unit 170) serving as a processing unit is provided with a plurality of pressing molds 171a and 171b that that apply pressure and heat from the circumference of the processing cylinder, and a pressing mold drive portion 172 that controls driving of the pressing molds 171a and 171b. With this configuration, without using a vacuum apparatus, it is possible to, easily and with a simple structure, affix the printed wiring board material MAT layered and formed on the surface of the processing cylinder 21 by pressing.

The pressing molds 171a and 171b, at not less than the curvature of the surface of the drum unit 20 (processing cylinder 21), have an appropriate curvature not greater than the curvature of the outer circumference of the printed wiring board 10 in a completed state, and are configured with a die heated to an appropriate temperature. Also, an appropriate pedestal (not shown) where the drum unit is placed is disposed between the opposing pressing molds 171a and 171b. The pressing mold drive portion 172 appropriately heats and moves the pressing molds 171a and 171b, and presses them against the printed wiring board material MAT, and is thus capable of affixing the printed wiring board material MAT with pressure.

As a means of moving and applying pressure to the pressing molds 171a and 171b, for example, it is possible to employ oil pressure, air pressure, or a ball and screw mechanism or the like, and as a means of applying heat, it is possible to employ an electric heater or a steam pipe built into the pressing molds 171a and 171b.

A temperature adjustment mechanism into which the drum unit 20 is built is desirably configured to operate in synchronization with the processing unit 170. With this configuration, it is possible to adjust the temperature of the printed wiring board material MAT in coordination with the mold pressing unit 170, so affixing of the printed wiring board material MAT with pressure can be performed swiftly and efficiently.

### Embodiment 10

In Embodiment 2, with respect to outer shape processing of the printed wiring board 10, a configuration was adopted in which after cutting into pieces with the laser processing unit, the pieces were removed from the drum unit 20 (see FIGS. 17B to 17D). However, in the present embodiment, after removing the pieces from the drum unit 20, outer shape processing is performed. Other aspects of the configuration can be the same as in Embodiment 2, so mainly the differing points are described here.

In order to cut (outer shape processing) the cylindrical printed wiring board 10 removed from the drum unit 20 (the printed wiring board material 10 shown in FIGS. 1A and 1B) into pieces, it is possible to adopt various methods, such as a method in which cutting is performed using a laser processing unit, or a method in which cutting is performed by a dicing apparatus having a rotating blade, a saw cutting apparatus having a blade that moves back and forth, a shirring apparatus that performs shearing processing or the like, or a method in which cutting is performed by combining the above methods.

Also, a cutting method is possible that involves a combination of, in a state with the drum unit 20 installed, pre-cutting to a particular size, and after removal from the drum unit 20 (see FIGS. 17B to 17D), applying these apparatuses (methods) to cut into pieces.

### Embodiment 11

In the present embodiment, Embodiments 2 to 10 are applied to the manufacture of an ordinary printed wiring board whose final shape is flat. Other aspects of the configuration can be the same as in Embodiments 2 to 10, so mainly the differing points are described here.

Specifically, when there are many layers in the final shape, or when using resin film in which fiber reinforcement or the like is not performed by an interlayer insulting resin layer, the printed wiring board in a completed state has a comparatively large amount of flexibility, so even if bent during manufacturing, it is possible for usage to be not much different from a conventional flat printed wiring board.

For example, when the interlayer insulating resin layer is polyimide film of about 18 μm to 25 μm, and the thickness of the conductor layer is from about several μm to 50 μm and up to about 6 layers, the same processing as in Embodiments 1 to 10 is possible.

Also, when adopting a thicker configuration, or when using material lacking in flexibility (for example, glass epoxy used as the interlayer insulating resin layer), it is possible to perform processing with resin hardening in each layering step being, for example, such that a half-hardened state is established that provides a contact state in which there is no displacement of the relative positions of each layer, until the final outer shape processing.

In the present embodiment, all processing of the printed wiring board is performed basically in a state wrapped around the drum unit 20, so there is no removal and turning of the printed wiring board as occurs with processing of an ordinary (flat) printed wiring board, so even when the interlayer insulating resin layer is not completely hardened, processing is not impeded. Also, in a partial processing step such as laser via processing, there is less change in size than with a conventional method, so there is also less possibility that defects occur, because there is little positional displacement during laser via hole processing, pattern formation, or the like.

After performing processing up to the final outer shape processing step according to Embodiments 2 to 10, the printed wiring board 10 is removed from the drum unit 20, and by applying heat and pressure with the printed wiring board 10 sandwiched by flat heating plates, flattening processing that corrects the cylindrically curved outer shape to a flat shape is performed. Afterward, appropriate surface treatment and final outer shape processing are performed to complete a flat (ordinary) printed wiring board.

### Embodiment 12

In Embodiments 2 to 11, printed wiring board material MAT was layered on the cylindrical drum unit 20, but in the present embodiment, instead of the cylindrical drum unit 20, a drum unit is applied that has the shape of a polygonal pillar. Other aspects of the configuration can be the same as in Embodiments 1 to 11, so they are appropriately cited in the description here.

FIG. 28 is a perspective view that conceptually shows the general configuration of a drum unit that is one example of a processing unit that serves as a constituent element of the printed wiring board manufacturing apparatus (printed wiring board manufacturing method) according to Embodiment 12 of the present invention.

A drum unit 180 serving as a constituent element of the printed wiring board manufacturing apparatus is provided with a processing cylinder 181, a rotational shaft 182, and a drive linking portion 184. The processing cylinder 181 constitutes a polygonal pillar-like outer circumference so as to function as a jig that holds a processing subject (printed wiring board material MAT), the rotational shaft 182 rotationally drives the processing cylinder 181, and the drive linking portion 184 is linked to a rotational drive unit 30 (see FIG. 3) that is linked to and drives the rotational shaft 182.

The processing cylinder 181 is configured from processing jig plates 181a, 181b, 181c, 181d, 181e, and 181f divided (integer m=3 or more; hexagon in the present embodiment, so m=6 with six sections) corresponding to each face of the polygonal pillar. Note that the surface of the processing jig plates 181a to 181f is flat, not curved. The processing jig plates 181a to 181f have a slight gap and are thus separated from each other, and are respectively linked to the rotational shaft 182. The processing jig plates 181a to 181f have a configuration such that their position in the radial direction centered on the rotational shaft 182 is changed by operation of a radial control lever 183.

The drum unit 180 is a substitute for the drum unit 20, so the drum unit 180 can be applied in Embodiments 1 to 11. Other aspects of the configuration are the same as in the drum unit 20, so a description thereof is omitted here.

Also, because the processing jig plates 181a to 181f are flat, it is possible to form a printed wiring board 10 with the shape of a hexagonal cylinder having flat faces that correspond to the processing jig plates 181a to 181f. In this case, it is possible to manufacture an ordinary printed wiring board, whose final shape is flat as in Embodiment 11, that corresponds to the flat faces of the processing jig plates 181a to 181f, but because the printed wiring board is flattened from the outset, it is not necessary to perform flattening processing (Embodiment 11) in which heat and pressure are applied by sandwiching the printed wiring board 10 between flat heating plates.

Further, by providing the surface of the processing jig plates 181a to 181f with appropriate undulation, it is possible to form a printed wiring board whose final shape is an undulating shape, and thus it is possible to manufacture a printed wiring board having a free shape.

### Embodiment 13

An electronic device according to the present embodiment is an electronic device in which a printed wiring board 10 according to Embodiment 1 is mounted, with a component being mounted on the printed wiring board 10. Also, as described above, the printed wiring board 10 can be formed by the printed wiring board manufacturing apparatus and printed wiring board manufacturing method disclosed as Embodiments 2 to 12.

FIG. 29 is a transparent side view that illustrates a state in which a printed wiring board according to the present invention has been mounted in an electronic device according to Embodiment 13 of the present invention.

An electronic device 200 according to the present embodiment, for example, is provided with a case 201 having a curved face that is cylindrical. In the case 201, whose storage space is cylindrical, a printed wiring board 10 is loaded, with a component 211 mounted on the printed wiring board 10. The printed wiring board 10 is configured with a curved face so as to match the curved face of the case 201, so the printed wiring board 10 is loaded in a high density mounting state without producing wasted space inside the case 201. Also note that the shape of the case 201 is not limited to a cylindrical shape; as long as the case 201 has a shape with a curved face, such as an arc, it is possible to attain the effects of the invention by applying the printed wiring board 10.

That is, in the electronic device 200, a printed wiring board 10 with high mounting density can be installed without wasted space, so the electronic device 200 can have a shape that is consistent with the purpose of the device, and the size of the electronic device 200 can be reduced.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. A printed wiring board manufacturing apparatus that manufactures a printed wiring board by performing processing on a printed wiring board material serving as a processing subject, the printed wiring board manufacturing apparatus comprising:
a drum unit having a processing cylinder that holds the printed wiring board material and comprises a cylinder outer circumference; and
a processing unit that performs processing on the printed wiring board material held by the processing cylinder.

2. The printed wiring board manufacturing apparatus according to claim 1, wherein the drum unit is provided with a temperature adjustment mechanism.

3. The printed wiring board manufacturing apparatus according to claim 2, wherein the temperature adjustment mechanism is configured to perform temperature adjustment with a supply of electric current.

4. The printed wiring board manufacturing apparatus according to claim 2, wherein the temperature adjustment mechanism is configured to perform temperature adjustment with a supply of fluid.

5. The printed wiring board manufacturing apparatus according to claim 1, wherein the drum unit is provided with an ultrasonic vibrator.

6. The printed wiring board manufacturing apparatus according to claim 1, wherein the processing cylinder has a processing jig plate divided in the outer circumferential direction, and is configured to change the radius of the cylinder outer circumference, which is configured by the processing jig plate, the amount of the change being a range from several tens of μm to several tens of mm.

7. The printed wiring board manufacturing apparatus according to claim 1, wherein the processing cylinder has the shape of a cylinder or a polygonal pillar.

8. The printed wiring board manufacturing apparatus according to claim 1, comprising a rotational drive unit that rotationally drives the drum unit.

9. The printed wiring board manufacturing apparatus according to claim 8, wherein the rotational drive unit comprises a drive control portion that controls rotation of the drum unit, and an interface portion that links to the processing unit.

10. The printed wiring board manufacturing apparatus according to claim 8, wherein the processing unit is a film layering unit that layers printed wiring board material on the processing cylinder, the film layering unit comprising a roll material supply mechanism that supplies to the processing cylinder, in a state maintaining tensile force, printed wiring board material rolled up in a roll, and a pressing mechanism that applies pressure to printed wiring board material supplied to the processing cylinder.

11. The printed wiring board manufacturing apparatus according to claim 8, wherein the processing unit is a film layering unit that layers printed wiring board material on the processing cylinder, the film layering unit comprising a sheet material supply mechanism that supplies to the processing cylinder, in a state maintaining tensile force, sheet-like printed wiring board material, and a pressing mechanism that applies pressure to printed wiring board material supplied to the processing cylinder.

12. The printed wiring board manufacturing apparatus according to claim 10, comprising a light-blocking mechanism that blocks light from printed wiring board material that is photosensitive.

13. The printed wiring board manufacturing apparatus according to claim 8, wherein the processing unit is a laser exposure unit, the laser exposure unit comprising a laser exposure head that, in a state in which the drum unit has been installed in the rotational drive unit, irradiates a laser beam synchronized with rotation of the processing cylinder onto printed wiring board material that has been layered on the surface of the processing cylinder, and a head movement portion that moves the laser exposure head parallel to the rotational shaft.

14. The printed wiring board apparatus according to claim 1, wherein the processing unit is a development unit comprising a rotational drive portion that rotationally drives the drum unit, and a development treatment fluid supply portion that supplies a treatment fluid for development to the processing cylinder.

15. The printed wiring board manufacturing apparatus according to claim 8, wherein the processing unit is a simplified development unit comprising a development treatment fluid supply portion that supplies a treatment fluid for development to the processing cylinder in a state in which the drum unit has been installed in the rotational drive unit.

16. The printed wiring board apparatus according to claim 1, wherein the processing unit is a plating pretreatment unit that comprises a treatment tank that houses the drum unit, and a treatment fluid circulation apparatus that circulates treatment fluid injected into the treatment tank around the circumference of the drum unit.

17. The printed wiring board apparatus according to claim 16, wherein the plating pretreatment unit comprises a plurality of treatment fluid tanks in which different treatment fluids are respectively stored, a discharge fluid pipe that discharges treatment fluid injected into the treatment tank, and a treatment fluid switching mechanism that injects a different treatment fluid than the discharged treatment fluid.

18. The printed wiring board apparatus according to claim 1, wherein the processing unit is an electroless plating unit comprising a treatment tank that houses the drum unit, and a treatment fluid circulation apparatus that circulates electroless plating fluid injected into the treatment tank around the circumference of the drum unit.

19. The printed wiring board apparatus according to claim 1, wherein the processing unit is an electrolytic plating unit comprising a plating tank that houses the drum unit, a plating fluid circulation apparatus that circulates electrolytic plating fluid injected into the plating tank around the circumference of the drum unit, and a plating electric current supply portion that supplies a plating electric current necessary for electrolytic plating treatment.

20. The printed wiring board apparatus according to claim 19, wherein the electrolytic plating unit comprises a plating precision adjustment mechanism that adjusts a state of circulation of electrolytic plating fluid, or a state of the surface of printed wiring board material.

21. The printed wiring board apparatus according to claim 19, wherein the electrolytic plating unit comprises an anode mud treatment portion that treats anode mud.

22. The printed wiring board apparatus according to claim 19, wherein the plating tank comprises an exhaust treatment portion that recovers and treats exhaust generated from the plating tank during electrolytic plating treatment.

23. The printed wiring board apparatus according to claim 19, wherein the plating tank is a cylindrical vertical-type plating tank in which the drum unit is disposed in the vertical direction.

24. The printed wiring board apparatus according to claim 23, wherein an anode electrode serving as the plating electric current supply portion is disposed along an inner wall of the plating tank.

25. The printed wiring board apparatus according to claim 24, wherein a gap between the anode electrode and the processing cylinder is uniform.

26. The printed wiring board apparatus according to claim 25, wherein the gap between the anode electrode and the processing cylinder is in a range from 5 mm to 30 cm.

27. The printed wiring board apparatus according to claim 24, wherein the anode electrode is disposed at a position facing the processing cylinder, and the length of the anode electrode in the vertical direction is not less than the length of the processing cylinder.

28. The printed wiring board apparatus according to claim 19, wherein the plating tank is a vertical rectangular body in which the drum unit is disposed in the vertical direction.

29. The printed wiring board apparatus according to claim 28, wherein the anode electrode serving as the plating electric current supply portion is bar-shaped, and is disposed at a corner in at least one location in the plating tank.

30. The printed wiring board apparatus according to claim 28, wherein the anode electrode serving as the plating electric current supply portion is plate-shaped, and is disposed along at least one face of the plating tank.

31. The printed wiring board apparatus according to claim 19, wherein the plating tank is a horizontal articulating-type plating tank in which a plurality of the drum units disposed in the vertical direction are arranged in a horizontal line.

32. The printed wiring board apparatus according to claim 8, wherein the processing unit is a laser processing unit, the laser processing unit comprising a laser processing head that, in a state in which the drum unit has been installed in the rotational drive unit, irradiates a laser beam synchronized with rotation of the processing cylinder onto printed wiring board material that has been layered on the surface of the processing cylinder, and a head movement portion that moves the laser processing head parallel to the rotational shaft.

33. The printed wiring board apparatus according to claim 32, wherein the light source of the laser beam is a carbon dioxide gas laser or a YAG laser.

34. The printed wiring board apparatus according to claim 1, wherein the processing unit is an application unit comprising an application fluid supply portion that supplies application fluid, and an application portion that applies application fluid supplied from the application fluid supply portion onto printed wiring board material that has been layered on the surface of the processing cylinder.

35. The printed wiring board apparatus according to claim 34, wherein the application unit comprises a film quality change portion that changes the application fluid that has been applied to the printed wiring board material to a resin film having a predetermined film quality.

36. The printed wiring board apparatus according to claim 1, wherein the processing unit is a vacuum press unit comprising a vacuum bag that houses the drum unit, a depressurizing apparatus that depressurizes the vacuum bag housing the drum unit, and a heating apparatus that heats the depressurized vacuum bag.

37. The printed wiring board apparatus according to claim 1, wherein the processing unit is a mold pressing unit comprising a plurality of pressing molds that apply pressure and heat from the circumference of the processing cylinder, and a pressing mold drive portion that controls driving of the pressing molds.

38. The printed wiring board apparatus according to claim 36, wherein the temperature adjustment mechanism is configured to operate in synchronization with the processing unit.

39. The printed wiring board apparatus according to claim 8, wherein the processing unit is a print unit comprising an ink ejection head that, in a state in which the drum unit has been installed in the rotational drive unit, in synchronization with rotation of the processing cylinder, ejects printing ink to printed wiring board material that has been layered on the surface of the processing cylinder, and a head movement portion that moves the ink ejection head parallel to the rotational shaft.

40. The printed wiring board apparatus according to claim 39, wherein the print unit comprises an ink drying apparatus that dries printing ink that has been ejected to printed wiring board material.

41. The printed wiring board apparatus according to claim 40, wherein the temperature adjustment apparatus is configured to operate in synchronization with the ink drying apparatus.

42. The printed wiring board apparatus according to claim 8, wherein the processing unit is a post-curing unit comprising an electromagnetic wave irradiation portion that, in a state in which the drum unit has been installed in the rotational drive unit, irradiates electromagnetic waves for post-curing to the processing cylinder.

43. The printed wiring board apparatus according to claim 1, wherein the processing unit is a polishing unit comprising a rotational drive portion that rotationally drives the drum unit, a polishing portion that polishes printed wiring board material that has been layered on the surface of the processing cylinder, and a polishing moving portion that moves the polishing portion parallel to the rotational shaft.

44. The printed wiring board apparatus according to claim 1, wherein the processing unit is an etching unit comprising a rotational drive portion that rotationally drives the drum unit, and an etching fluid supply portion that supplies etching fluid to the processing cylinder.

45. A printed wiring board in which a wiring pattern having a component mounting land portion has been formed on an insulating substrate, wherein
the insulating substrate is curved in an area where the component mounting land portion has been formed.

46. The printed wiring board according to claim 45, wherein the insulating substrate has the shape of a cylinder.

47. The printed wiring board according to claim 45, wherein a conductor layer different from a conductor layer comprising the component mounting land portion is formed.

48. A method for manufacturing a printed wiring board by layering a printed wiring board material with which a printed wiring board is formed, and performing processing on the printed wiring board material, the method comprising:
a cylinder preparation step of preparing a processing cylinder on which printed wiring board material will be layered;
a material layering step of layering printed wiring board material on the processing cylinder;
a processing step of performing processing on the printed wiring board material that has been layered on the processing cylinder; and
a removal step of removing a printed wiring board formed by repeating the material layering step and the processing step from the processing cylinder.

49. An electronic device in which a printed wiring board is mounted, a component being mounted on the printed wiring board, wherein
the printed wiring board is a printed wiring board according to claim 45.
